(19) United States
(12) Patent Application Publication
(10) Pub. No.: US 2002/0120697 A1
(43) Pub. Date: Aug. 29, 2002

(54) Multi-channel messaging system and method

(76) Inventors: Curtis Generous, Great Falls, VA (US); Richard Dunbar, Alexandria, VA (US); Jerry Rusnock, Gaithersburg, MD (US); Matthew Whalen, Arlington, VA (US); Christopher Shenton, Washington, DC (US)

Correspondence Address: GREENBERG TRAURIG, LLP, Suite 1200, 1750 Tyson's Boulevard, McLean, VA, 22102, US

(21) Appl. No.: 09/930,496

(22) Filed: Aug. 16, 2001

Related U.S. Application Data
(60) Provisional application No. 60/311,813, filed on Aug. 14, 2001.
(60) Provisional application No. 60/224,507, filed on Aug. 14, 2000.

(51) Int. Cl. G06F 15/16

(52) U.S. Cl. 709/206

(57) ABSTRACT

A system for delivery of a message to a subscriber over multiple communications channels includes means for accepting the message from a sender, means for determining a sequence of the communications channels for delivery of the message based on a subscriber profile, and means for delivery of the message over at least one of the communications channels until acknowledgement of message receipt by the subscriber.

This application claims priority to U.S. Provisional Application No. 60/224,507, filed on Aug. 14, 2000, and to U.S. patent application No. ______, entitled MULTI-CHANNEL MESSAGING SYSTEM AND METHOD, filed on Aug. 14, 2001, which are both incorporated by reference herein.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Filed of the Invention

This invention relates to delivery of electronic information to its intended recipient over a network, and more particularly, to delivery of information, such as a message, over multiple communication channels in a manner that increases the likelihood of receipt by the recipient.

2. Discussion of the related art

Although a number of methods currently exist to deliver information, such as email, to a recipient, these methods suffer from a number of drawbacks. One of these drawbacks is a general difficulty in the sender knowing whether and when the intended recipient received the message, particularly when the information is time sensitive, and the recipient is capable of receiving the message on multiple communications channels, such as email, voice message, Instant Messenger, pager, etc.

Accordingly, there is a need for a system and method that substantially increases the likelihood of receipt of the message in the shortest possible time.

### SUMMARY OF THE INVENTION

In a preferred embodiment, the invention provides a high-performance message distribution engine for delivering large volumes of customized messages via multiple delivery channels, tracking message queuing and delivery status, tracking message access by recipients, performing automatic alternate delivery of messages upon encountering errors, performing automatic alternate delivery of messages when recipient fails to read the message within a pre-configured amount of time, and providing immediate and summary reports to clients and administrators of the system.

Alternate “Delivery Agents” are provided for delivering messages to a recipient via alternate paths, such as e-mail, pager, voice, FAX, or instant message. A “Message Rollover” or “Message Roaming” function is provided for sending a message to a recipient using alternate e-mail addresses or message delivery agents if the primary delivery agent fails to deliver the message or the message is not acknowledged within a pre-determined amount of time.

The system of the invention encompasses a rules-based delivery engine, which provides for a per-recipient profile database, which allows for an automated selection of the optimal delivery channel, based on such factors as priority of message, time of day, type of information, past delivery history, type of client software used, etc . . . The system of invention includes a system architecture which is highly scalable, fault tolerant, and supports geographical diversity and a fully distributed architecture, capable of high volumes of traffic with respect to each of the above functions. The system of the invention can be used to distribute large volumes of messages, newsletters, alerts, electronic documents, and other multimedia information. Interfaces are provided for allowing third-party clients to use the system to send large volumes of messages and receive reports on the delivery status of their customizable messages. This and other auditing, tracking and reporting functionality allows the system in its preferred embodiment to be operated as a service bureau.

### BRIEF DESCRIPTION OF THE ATTACHED DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a diagram illustrating the message assembly and delivery processes of the invention in accordance with a preferred embodiment.

FIG. 2 shows a diagram illustrating an overview of the architecture of the system of the invention in accordance with a preferred embodiment.

FIG. 3 shows a diagram illustrating the reporting subsystem and related subsystems in accordance with a preferred embodiment of the invention.

FIG. 4 shows a diagram illustrating the reporting subsystem and its data store according to a preferred embodiment of the invention.

FIG. 5 shows a diagram illustrating the assembly engine and its related subsystems in accordance with a preferred embodiment of the invention.

FIG. 6 shows a diagram illustrating the tracking subsystem of the invention according to a preferred embodiment.

FIG. 7 shows a diagram illustrating the instant messenger subsystem of the invention according to a preferred embodiment.

FIG. 8 shows a diagram illustrating process distribution in the system of the invention according to a preferred embodiment.

FIG. 9 shows a diagram illustrating service management in the system of the invention according to a preferred embodiment.

FIG. 10 shows a diagram illustrating the database architecture of the system of the invention according to a preferred embodiment.

FIG. 11 shows a diagram illustrating the web server architecture of the system of the invention according to a preferred embodiment.

FIG. 12 shows a diagram illustrating the application server architecture of the system of the invention according to a preferred embodiment.

FIG. 13 shows a diagram illustrating the delivery agent architecture of the system of the invention according to a preferred embodiment.

### DETAILED DESCRIPTION OF THE PREFERRED EMBODIMENTS

The system of the invention in its preferred embodiment provides operations which encompass a complete lifecycle of electronic communications, including ‘mailing’ initiation, pre-processing and message assembly, scheduling, delivery, tracking and reporting. Certain broad features of the invention will be discussed firstly below.

Message Priority

The system of the invention provides for individual message priorities to be set, and for that information to be used to determine the delivery sequence of these messages. Multiple priority levels for messages may be supported in the system of the invention. These priorities may be, e.g., Bulk, Normal, Alert, Blast, and Priority -[1-5]. Higher priority messages will always take precedence over lower priority messages. The system of the invention uses the priority information of the message to determine the order in which a message should be processed relative to other jobs being performed Message Priority for delivery is discussed in detail in the E-mail Delivery Agent (EDA) Subsystem section below. The user/customer provides a priority for all messages in a submission and that priority will be assigned to each message.

Rollover or Message Roaming

The “Rollover” or “Message Roaming” feature of the invention provides the ability to send a message to a recipient using multiple alternate delivery channels or message delivery agents should the primary delivery agent fail to deliver the message or not be acknowledged within a specific time frame. Rollover will occur for a message if specified in client input for a recipient and if the message delivery fails for the primary or more preferred delivery agent. Message delivery failure may be determined, e.g., based upon feedback from remote message transfer agents (MTAs), discussed in further detail below. Multiple levels of rollover are preferably supported.

The message roaming feature of the invention provides for a much greater delivery completion success by providing the ability for multiple delivery channels to be tried, either in succession (Alert) or in parallel (Blast), until a success condition has been met. The trigger mechanism for the rollover feature to be activated include such conditions as:

Failure reported by a delivery agent (DA) when attempting to deliver a message. Failures are classified by either a hard-error (permanent) or soft-error (temporary). Different actions can be taken when encountering either hard or soft errors.

Inability of a delivery agent to contact the remote device after a pre-determined amount of time (time based rollover or TBR)

The ability to trigger an alternate delivery channel based on the user's profile and/or based on policy/rules (e.g. send information to a pager if a critical message is sent during non-business hours).

Unified Message Tracking

The system of the invention provides for the ability to gather real time statistics on the actions of delivery, reading, bouncing, forwarding, in-transit, queued, and replies. The status of each message is tracked so that clients may query for the status of messages and for summary reporting of submissions. The system should be able to trace message assembly, queuing, delivery and failures, to remote destinations, independently of the communication channel used.

The date and time the message was read should also be tracked. These data are recorded each time a message is read.

The recipient's software provides functionality for reading the message, time message was read, message size, network location, connectivity speed and any other attributes that can be gleaned about the user. Data extracted from a recipients' browser are collected by a Web Agent (WAG). The WAG sub-system is described in further detail below; WAG Subsystems requirements are set forth below and identify which information is to be tracked.

An Out of Band Subsystem receives and initiates tracking of bounced e-mail and autoreply messages.

Both Variable Envelope Return Path (VERP) and Delivery Status Notification (DSN) are preferably supported. Known ways to track messages should be supported. Their use may be configurable by a Systems Administrator where necessary. DSN “success” messages may be used but may not necessarily be “on” by default.

The use of delivery channel-specific VERPs are the preferred principle method used to track and identify errors relating to a message. All information necessary in processing and tracking requests must be made available by knowing the VERP.

Message Transfer Agents Probes/Health Probes

Independent software entities may be provided which periodically connect to, and sense the operational status of, remote message transfer agents (MTAs) throughout the top one thousand domains in use by the system. Connection times, MX server preferences, etc., can all be recorded and analyzed to provide a set of ‘best bet’ MTA server addresses for each domain at any given time prior to the time when they are needed by the DAs. This set of MTA server addresses can be referenced instead of the more time-consuming DNS for 95+% of all outbound mail. Additional health-probes may be used to determine the operational status of other remote servers (e.g. AOL AIM servers) and used by the appropriate DA's.

Message Expiration Time

All messages within a single submission preferably have one and the same associated expiration time. The default expiration time for the system may be set at, e.g., three days from the time of scheduled delivery. Expiration date and time are specified in Universal Time Coordinated (UTC). Values for expiration time should be able to be configured at the system level, at the client level and at the submission level.

Messages that exceed the expiration time set for them are deleted from the message queue. Messages are not assembled if the anticipated assembly time exceeds the Expiration Time. Tracking information is submitted to the Delivery Scheduler for entry into the Tracking Database tables for each message deleted from the message queue or not assembled due to exceeding expiration time.

Custom Messaging

Clients/users of the system are provided with the ability to customize messages sent to their recipients on a per-user basis for content in the message by using variable substitution. Global defaults may be set for all messages in a submission. Per-recipient values will always supercede global values. Clients are able to customize message per Delivery Type on a per-user basis. There is preferably one, non-recursive level of substitution done per message. The customization data is provided in the client's submission. The following data elements may need to be accommodated in the submission:

Recipient's zip code

Recipient's city

Recipient's state

Recipient's area code

Recipient's name

Recipient's delivery time

Secure Encrypted Mail

The system of the invention includes functionality that provides for various security features to be associated with a message.

Messages sent by a user of the system may be encrypted, either by the user or by the system itself, and mechanisms for decrypting messages at the recipient end once the message is received.

Messages sent by the system may include ‘conditional’ events that determine whether or not a message is able to be read by the recipient. The possible conditions may include, in part, such variables as:

Was the message received by a authenticated recipient, using the PKI infrastructure and digital certificates such as those commercially available by organizations like Verisign. The use of S/MIME is envisioned as the preferred mechanism for this purpose.

Is the message attempted to be read by an approved IP address?

Is the message attempted to be read within a preset time frame? Within specific time windows (e.g. business hours only)?

Is the message attempted to be read originating from a pre-approved software module (e.g. allow message to be read by a Eudora mail client but not by an AOL mail client).

Comparing the source of the mail read request to previous successful requests and deny if source if different.

Shreddable Mail

The system of the invention may include functionality which allows a sender to associate rules with a message to determine if it can be opened and read by the recipient. In this respect, the system allows the sender to determine that messages which do not meet the rules (e.g., they are not delivered or read before a certain date) are automatically deleted. Some of the rules that may be used include:

Time Lapse: message must be read within a certain time frame or it becomes unavailable (ala ‘shredded’ metaphor)

Delete after read once (i.e. mission impossible metaphor: ‘this message will self destroy in 5 seconds’)

Who reads it: require that the message be read from a specific device (e.g. IP address). Password access can be enabled.

In one embodiment, messages containing only a URL are delivered to a recipient; the content is available only via click through to the Web Delivery Agents (discussed in further detail below) and may, therefore, be deleted under certain conditions or at certain times, e.g., when the message is read once or after a certain time has elapsed.

Recipient Data and Client List Management

Clients/users of the system are responsible for recipient list management and all messages submitted to recipients. The client provides subscribe/unsubscribe information in each message. That information preferably includes either a URL or an e-mail address that can be used by a recipient to subscribe/unsubscribe. A client is able to send messages to its full list of recipients, but is preferably excluded from sending messages to a subset of their recipient list. A client who wishes to send messages to subsets of their recipient list is thereby forced to separately register each submission.

Recipient data is persistent across all clients and submissions. A client may given the ability, through a directive in a submission, to request that the recipient list not be persistent. A client's recipient list data will be persistent across submissions. A client's recipient list data may point to global recipient data. There will be a “blacklist” of domains and recipients which are not to receive messages.

Message Delivery by Recipient's Geographic Location

Messages for recipients are preferably deliverable based on the client's input of geographical information included within the submission input. The Delivery Scheduler provides functionality to segregate messages based on the attributes listed below and sent to a specific Assembly Engine for assembly and delivery based on local time of the recipient.

Segregation attributes include, but are not limited to, the following:

ZIP code

City

State

Country

Phone number Area Code

Time zone data (e.g. EDT, PST)

Latitude/Longitude data

An example of this use would be a client who wants all messages delivered by 8:00 am local time for the recipient. Delivery of the messages could be split up as to deliver Easternmost time zone messages first and then follow with following time zones. Messages for other time zones might be transferred to a remote location for assembly and delivery.

Guaranteed Mail

In accordance with one feature of the invention, functionality is provided whereby operators of the system can guarantee that a message will be delivered to its recipient, except where the recipient's id no longer exists or is unreachable, etc. In this respect, the system may include functionality for embedding special data tags in electronic messages that trigger specific, detectable events to occur on the system's servers. These data triggers are used to record all activity associated with the ‘history’ of a message, including whether or not a message has been received and acted upon by a recipient. This, combined with the Out Of Band (OOB) error handler, provides the ability to ‘guarantee’ to a sender that a message was successfully received and read by a recipient.

Overall System Operation

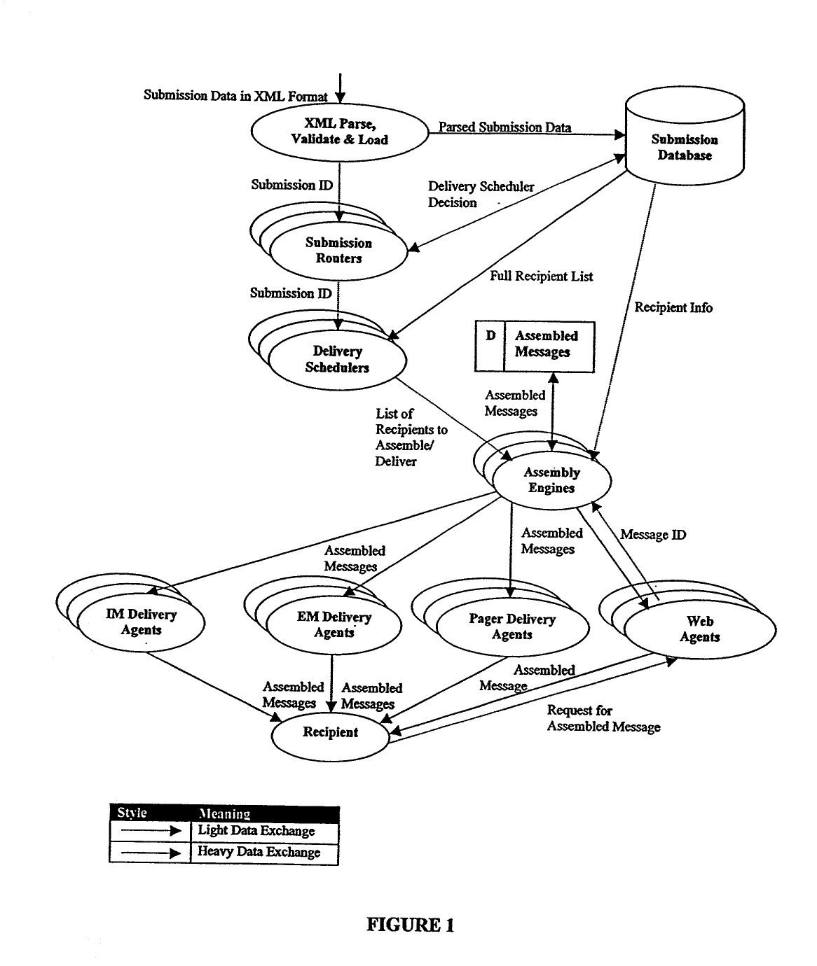

FIG. 1 shows the message assembly and delivery processes of the invention in accordance with a preferred embodiment. At “Input”, submission data is accepted in XML format. The XML Parser then parses the input data, stores the parsed data in the Submission Database, stores the unparsed XML input file in the Archive Database, and informs a Submission Router of the new submission. The XML Parser creates the submission ID for the new submission.

Submission Routers are provided for keeping track of which Delivery Scheduler is handling a particular submission. The Submission Router is responsible for deciding which Delivery Scheduler (discussed in detail further below) should handle a particular submission. This decision is stored in the database for future reference by other Submission Routers. The Submission Router should communicate with that Delivery Scheduler and inform it that it is responsible for that submission.

If a given Delivery Scheduler should become unavailable, the Submission Router should find another Delivery Scheduler to take over all of the submissions currently being handled by the failed Delivery Scheduler. The Submission Router should notify the new Delivery Scheduler that it is now tasked with handling the submission.

In order to meet the above obligation, it may be necessary for the Submission Routers to monitor the health of the various Delivery Schedulers. They should not only monitor whether they are up or down, but how busy they are.

If a process asks the Submission Router which Delivery Scheduler is responsible for a particular submission, the Submission Router checks it own cache to determine the correct answer. If the answer is not in the cache, the Submission Router gets the answer from the database.

The Delivery Schedulers are provided for keeping track of the status of each message for a particular submission. A Delivery Scheduler initiates assembly and delivery as needed. The Delivery Scheduler keeps track of the assembly status for each message of a particular submission that is scheduled for future delivery. The Delivery Scheduler keeps track of when submissions should run. A given submission is handled entirely by a particular Delivery Scheduler.

When the Delivery Scheduler is told that it is responsible for a submission, it spawns a new thread, retrieves all of the submission data from the database and builds it own internal data structures.

If any process in the system comes to the conclusion that a particular recipient should have their message sent via their second or third delivery option, that information is directly passed to the appropriate Delivery Scheduler. That process will ask the Submission Routers which Delivery Scheduler is handling that submission.

If any process determines that a particular recipient has received their message and no more messages should be sent, that information is directly passed to the appropriate Delivery Scheduler.

When the Delivery Scheduler talks to a particular Assembly Engine, it tells the Assembly Engine whether the data should be handed to a Delivery Agent immediately, or whether it should be stored in the Assembled Messages Data Store (for pre-assembled submissions).

The Delivery Scheduler submits a list of recipients (typically 1,000 at a time) that need to be assembled to any given Assembly Engine. The Assembly Engine then retrieves message templates, message style sheets, and all of the recipient information directly from the submission database.

Submissions that should not be delivered immediately are put into a timer queue. The messages are all assembled. The data structure holding the submission linked list is deleted. When the time comes to deliver the submission, the database is queried and the submission linked list is rebuilt. The delivery is then started.

With continuing reference to FIG. 1, an Assembly Engine takes the message template, the message style sheet and recipient information and combines them to create the message which is to be delivered. Any process that communicates with the Assembly Engine do tells the Assembly Engine to either store the assembled message in the Assembled Messages Data Store or to contact a particular type of Delivery Agent.

Any process that communicates with the Assembly Engine tells the Assembly Engine whether that particular message has been pre-assembled. If the message has been pre-assembled, the Assembly Engine merely reads the message from the Assembled Message Data Store. If the message has not been pre-assembled, then the Assembly Engine assembles the message.

Any process that communicates with the Assembly Engine tells the Assembly Engine the range of recipient IDs which are to be assembled.

An Assembled Messages Data Store is provided for storing pre-assembled messages. A hashing function should be used to determine where to store the assembled message. This should be a function of the recipient ID and the delivery option.

Delivery Agents are provided for receiving assembled message and delivery information and delivering the message. The messages are dropped into queues and delivered as soon as possible. If a delivery attempt fails fatally, that information is communicated to the appropriate Delivery Scheduler.

Web Delivery Agents are provided for delivering an assembled web message to a client. The Web Delivery Agent should directly notify the appropriate Delivery Scheduler that the recipient has asked for the web message.

A web tracking agent is provided for reporting the retrieval of tracking images embedded in messages. The Web Tracking Agent should directly notify the appropriate Delivery Scheduler that the recipient has asked for the web message.

An Out-Of-Bounds (OOB) handler is provided for handling out-of-bounds messages. When a message bounces, 3^{rd} party ACK, ASCII email ACK, or a Delivery Status Notification (DSN) arrives, it is received by the OOB Handler. The OOB Handler notifies the Delivery Scheduler of the bounce so that the Delivery Scheduler can immediately initiate the assembly/delivery of the second or third delivery option.

Subsystems

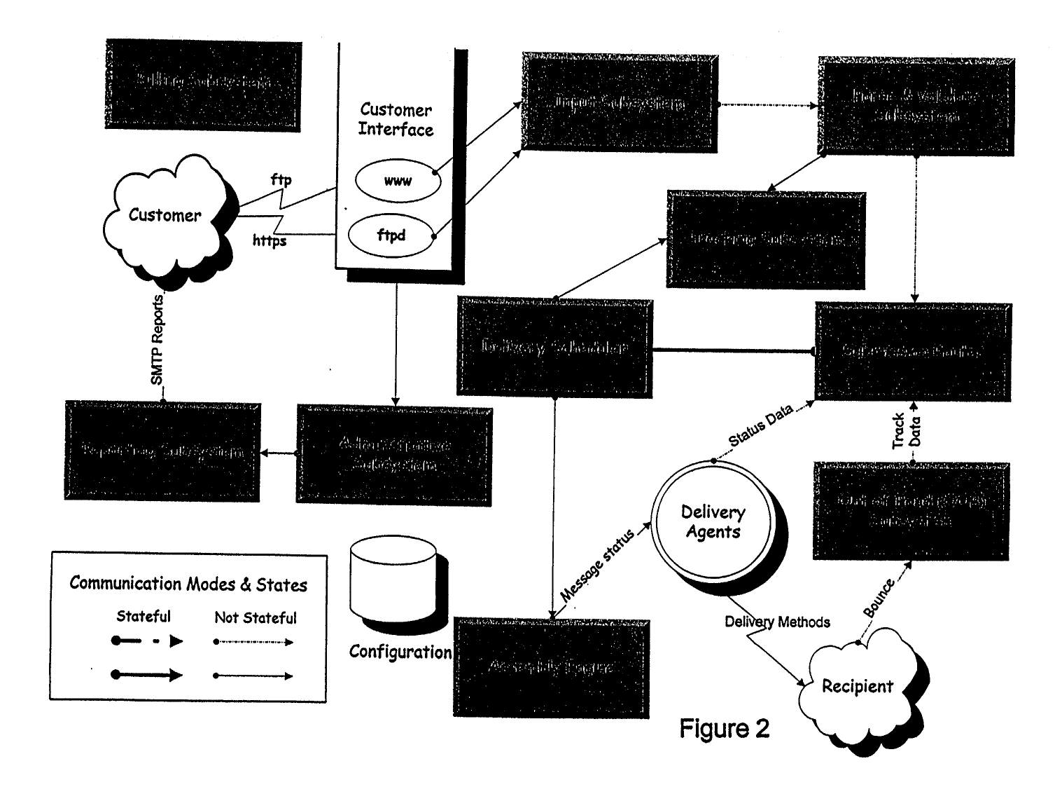

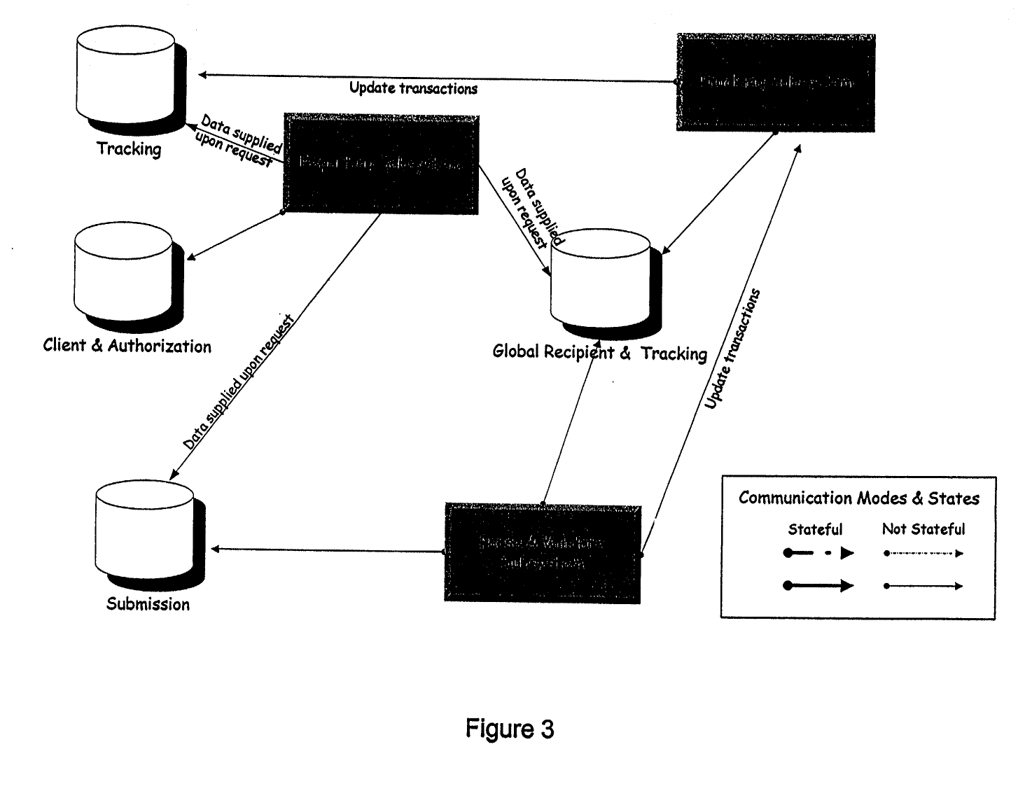

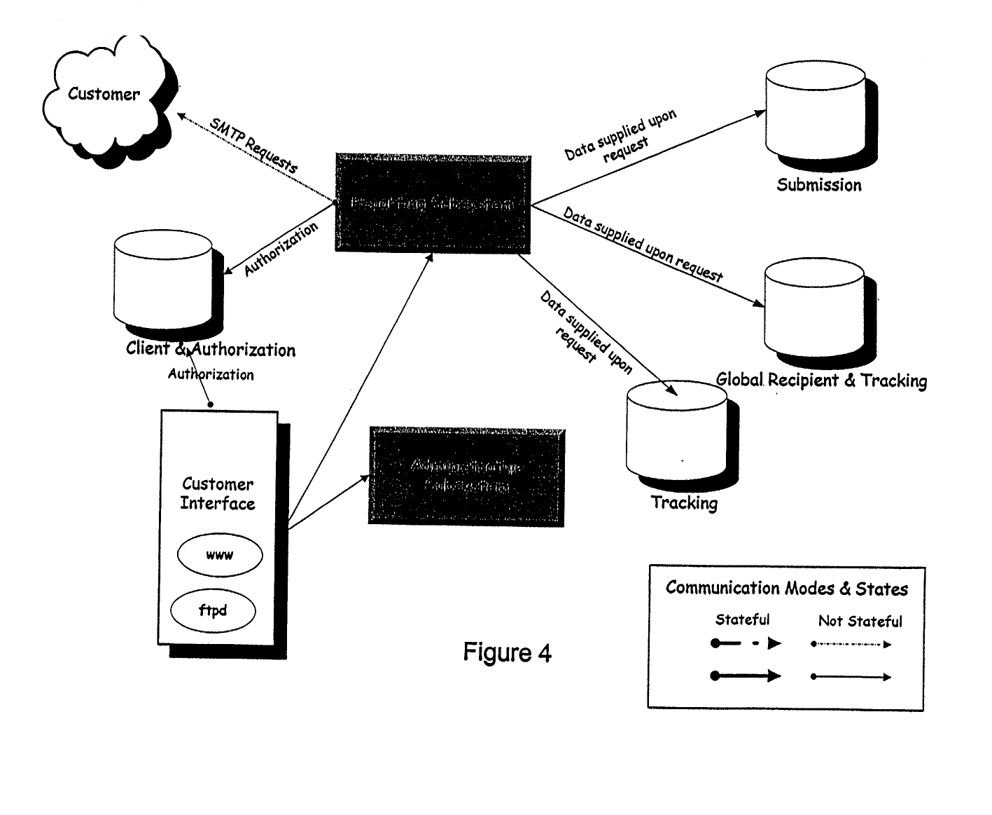

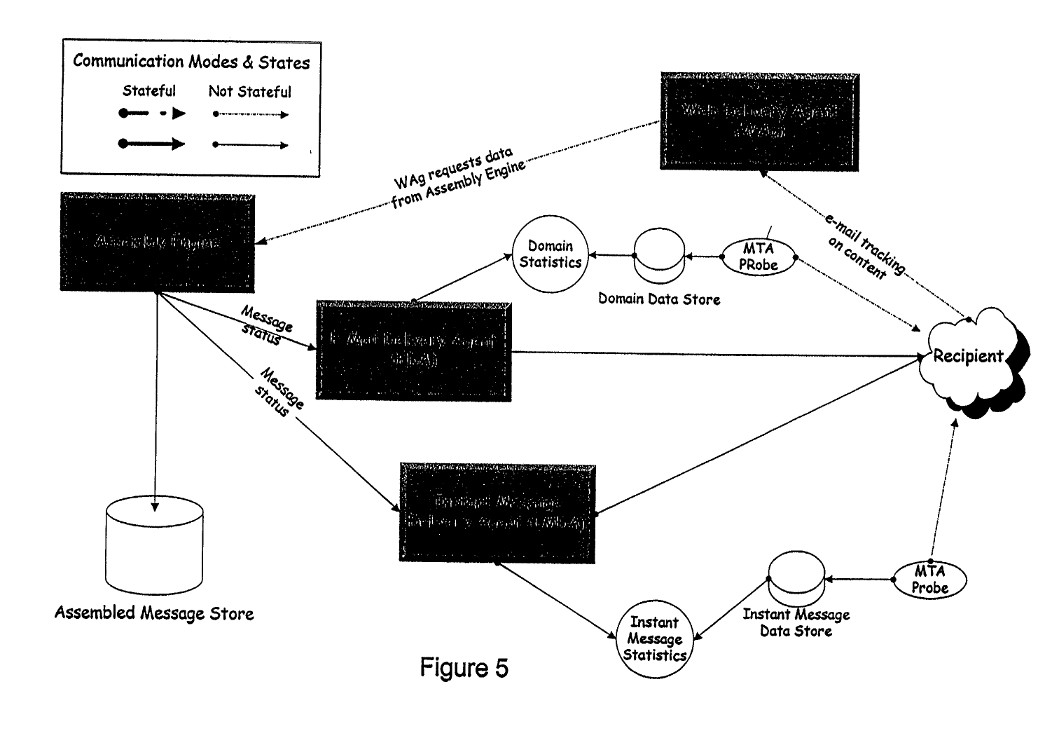

Diagrams of the Subsystems of the invention in a preferred embodiment appear in FIGS. 2 through 7.

The system's engine in its preferred embodiment is comprised of the following subsystems:

Data Upload

Parse Validate and Load

Submission Router

Delivery Scheduler

Assembly Engine

Administrative Interface

Reporting (Internal & External)

Wag

EDA

IMDA

DAStats

MTA Probe (MTAP)

Logging

Tracking

Each of these subsystems will be described in detail further below.

Subsystem State Information

Every subsystem writes its state information to a database or to a file on an NFS-mounted file system. If the data are on an NFS, then MAILDIR format will be used. The data will be used by the Administrative Interface for displaying subsystem status. At a minimum, the following state information is required:

Subsystem name

Process ID of the parent process

State (up/down/starting/stopping)

Last update time

General metrics that will indicate load

The update interval is specified in a Configuration Database, discussed below. All state changes will require an update. The lack of any update within a period that is twice the length of the specified update interval will be interpreted as an indication that the particular subsystem is down.

All configuration information for all subsystems is preferably stored in a Configuration Database. All subsystems obtain their configuration information from this Configuration Database.

All daemons preferably follow general Unix conventions for responding to signals. These conventions include the following:

| | |
|---|---|
| HUP (1): | Read the configuration file and reinitialize |
| TERM (15): | Shutdown |
| USR1 (16): | Increment debug by one level |
| USR2 (17): | Halt debug |
| STOP: | Suspend |
| CONT: | Continue |

All signals should be handled consistently across all subsystems. A consistent signal should be used to dump state information to a flat file.

Each subsystem writes its state information to a database or to a file on an NFS-mounted file system. If the data are on an NFS, then MAILDIR format may be used. The data is used by the Administrative Interface for displaying subsystem status. At a minimum, the following state information will be required:

Subsystem name

Process ID of the parent process

State (up/down/starting/stopping)

Last update time

General metrics that will indicate load

Uptime

The update interval is specified in the Configuration Database. All state changes generally require an update.

The system of the invention preferably includes functionality for processing and responding to automated response messages from recipients.

All blocking calls (reads/writes) should be wrapped with a SIGALARM to prevent deadlocks.

With continuing reference to FIGS. 2 through 7, each subsystem will be discussed in detail below.

Logging Subsystem

A logging subsystem is provided for logging system events and errors to log files. The logging Subsystem should rotate logs and remove old logs based on the configuration information as specified in the initialization function. Log rotation preferably occurs as part of re-initialization after the reception of a HUP signal. The logging Subsystem should be re-entrant, thread-safe and as non-blocking as possible.

If writing a log message or opening a log file fails for any system administrator recoverable problem, then block all logging calls from returning control to the application and send the error to standard error and the SNMP monitoring station with an Emergency message level.

A Logging library is preferably provided and can be linked with any application or subsystem of the system of the invention. The logging library should contain an initialization function which accepts information on the service name (what the calling service will be called in the logs) to write in the log file. The logging library contains functions to write messages to logs. Each function accepts a severity level, a debug level to determine if the log message should be written or ignored and a variable number of parameters with substitutions to define the message. The logging library preferably only logs full lines. It should be re-entrant, thread-safe and as non-blocking as possible. If writing a log message or opening a log file fails for any system administrator recoverable problem, then all logging calls are blocked from returning control to the application and the error is sent to standard error and the SNMP monitoring station with an Emergency message level.

The severity levels that the logging Subsystem should understand are the same as syslog—DEBUG, INFO, NOTICE, WARNING, ERROR, CRITICAL, ALERT, and EMERGENCY.

The format of a log file line is preferably as follows:

YYYY/MM/DD HH:MM:SS hostname service[pid] severity: message filename:linenumber

The logging library preferably contains functions which accept a service name, message severity level, debug level, and log message. Based on the inputs, the log library will determine if the message should be written to a log file. If the message is written to a file, the library will construct the log message line and send an SNMP trap if appropriate for the message based on the severity. The log library will send messages to a message queue for being written to disk. A success or failure message will be sent to the calling application.

Logging Daemon

A Logging Daemon is provided for consolidating messages for all Ranger (eFoton) processes running on the system(s). The logging Subsystem preferably contains an initialization function which accepts information on directory in which to store logs, log filename, service name to write in the log file, retention length before removal of old log files, rotation frequency in minutes, and size at which to rotate files. Default values are: log rotation frequency are 60 minutes, size at which to rotate files is 10 MB, directory is “/var/log”, filename is the same as service name. Service name is not optional.

The logging Subsystem preferably sends an SNMP trap to the monitoring station based on a configuration parameter. If not specified in the configuration database, messages of severity level “Warning” or higher will result in SNMP traps being delivered to the SNMP monitoring station. [i.e. TrapDebug=FALSE, TrapError=TRUE]. After being rotated, logs will be compressed using a compression utility.

The log daemon receives input from the configuration database and the log message queue. Optionally, the log daemon may receive messages via a TCP connection from other log daemons. The log daemon writes the log messages to the appropriate file or sends the messages to another log daemon via TCP for writing.

Tracking Subsystem

The invention includes a Tracking Subsystem for collecting and storing tracking data from the Ranger subsystems to allow tracking of messages from submission, through processing, to delivery to, and reading by, the recipient. The tracking subsystem preferably comprises the following elements:

Tracking Library

Tracking Daemon

Tracking Data Store

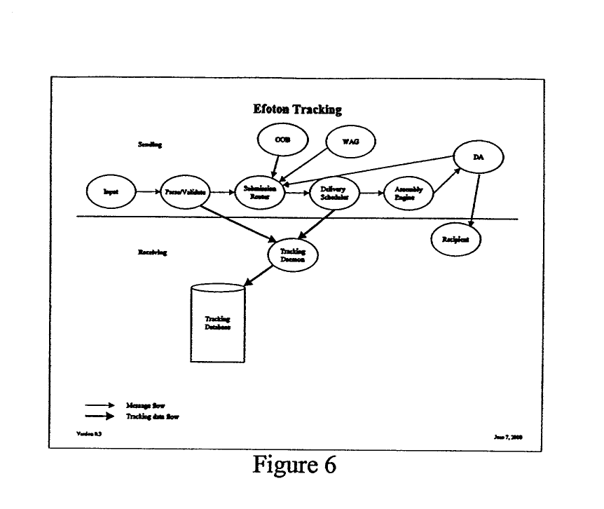

These elements are illustrated in FIG. 6, and are described below.

The tracking library is a library that can be linked with any application or subsystem of the invention. The tracking library is be re-entrant, thread-safe and as non-blocking as possible. If writing to the tracking data store fails for any reason, control is returned to the application, the error is recorded in the Subsystem State Table and the Logging Subsystem sends an SNMP trap at the EMERGENCY level to the Network Monitoring System.

The status of each message is tracked so that clients may query for the status of messages and for summary reporting of submissions. The system should be able to trace message assembly, queuing attempted delivery, delivery, message expiration and rollover. The date and time the message was read will be tracked if at all possible; advertisements, messages, and submission progress will also be tracked.

The recipient's software for reading the message, time message was read, message size, network location, connectivity speed and any other attributes that can be gleaned about the recipient. Data extracted from a recipients' browser should be collected by the Web Agent (WAG). The WAG sub-system is described in detail below.

The Out of Band Sub-system will update tracking of bounced messages and messages generated by auto-responders.

The following data will be stored in the tracking database. Data will be submitted to the Submission Router by the Delivery Agent.

MessageID

Success/hard failure

Reason for failure

MTA speed in bytes per second

Date & time recorded in UTC. The date should include a 4-digit year. Time will be recorded to the millisecond, and if possible, to the microsecond.

RecipientID

SubmissionID

The Tracking Subsystem updates the Message Table with the following on behalf of all DAs upon receipt of a delivery success/hard fail:

| | |
|---|---|
| Status | (delivered / failed / trying alternate DA) |
| UpdateDt | (record update date-timestamp |
| DaType | DA which delivered or last DA tried |

The tracking library contains functions accepting tracking data to be sent to the tracking daemon. The data includes the following data elements (not inclusive) from the subsystems for storage in the tracking data store:

trackingID-tracking module generated

trackingdate

trackingTime

clientID

submissionID

messageID

recipientID

module-submission router, parse/validate, assembly, E-mailDA, IMDA, WAG, OOB

moduleStatus-status of module processing, possible valid values (not inclusive):

—MTA accepted

—MTA deferred

—MTA reject

—Ranger queued

—Deferred queue

—Roll over attempted

—IM expired

—Ad expired

—Delivery success

—Delivery failure

—Message read

—Received

—Received format check-ok

—Assembly scheduled

—Assembly started

—Assembly complete

—Delivery started

—Delivery complete

—Message delivered

—Message assembled

—Message delivery failed—retry

—Message delivery failed—rollover

—Message delivery failed—hard

—Message bounced

—Message deferred

—Message read

—Administratively deleted

—Error code

—MessageReadTime

—MessageReadDate

—MessageDeliveryCost

—DeliveryClass (E-mail, IM, Pager, WAG)

—E-mailAddress

—Domain

—Mua

—IspMTA

—Browser

—RecipientConnSpeed

—IspConnSpeed

—ImURL

—ImID

—SuccessDeliveryDate

—SuccessDeliveryTime

—Ad clicked

—moduleStatusValue

As set forth above, the tracking library contains functions that send messages to the tracking daemon. Success or failure indication is returned to the calling application. Data sent to the tracking daemon includes the Input data elements described above.

A tracking daemon is provided which accepts tracking messages from all Ranger processes running on the system(s). The Tracking Subsystem updates the Message Table with the following data on behalf of all Delivery Agents upon receipt of a delivery success/hard fail:

| | |
|---|---|
| Status | (delivered / failed / trying alternate DA) |
| UpdateDt | (record update date-timestamp |
| DaType | DA which delivered or last DA tried |

The tracking daemon receives configuration information from the configuration database. The tracking daemon is also preferably able to receive messages from a TCP connection from remote systems of the invention. The tracking daemon further accepts data destined for the tracking data store from all subsystems.

The tracking daemon formats its received data into properly formatted SQL statements for inserting tracking data into the tracking data store. The tracking daemon queues tracking data in a tracking data cache to allow batch tracking data inserts into the tracking data store. The tracking daemon validates incoming data (range checks, format, etc.). Data checking is intended for internal error checking. Invalid data will be logged via the logging facility.

The tracking daemon reports errors via the Logging Subsystem and the SNMP monitoring station with an appropriate level message. In the case of data store failure or non-response, the tracking daemon queues tracking data in a tracking data cache, block all tracking calls from returning control to the application and send the error to standard error and the SNMP monitoring station with an Emergency message level. The tracking daemon reports erroneous data inputs via the Logging Subsystem.

The tracking daemon submits tracking data entries to the tracking data store. In the case of an error, the tracking daemon sends error messages to the Logging Subsystem and the SNMP monitoring station with an Emergency message level.

Data Upload Subsystem

A Data Upload Subsystem is provided for receiving and processing uploaded data from clients. The input process may be made available 24×7 and may run on more than one machine. Electronic submission may be made with HTTP/HTTPS, SMTP, or FTP, should be stored on an NFS-mounted partition and should be lock-free. MAILDIR format should be used. The submission of file decompression will create a single uncompressed file.

Upon successful reception of incoming data, a unique submission ID is assigned. Receipt of data is tracked. Each submission is preferably stored in a directory named for the client-employee who transmitted the submission. A unique filename is assigned to a new submission. The Data Upload Subsystem will obtain all required configuration information from the Configuration Database.

Data which is received by the Data Upload Subsystem includes desired delivery time for data, including time zone, the priority for the groups of e-mails (e.g., bulk, normal and expedited), the Job-ID (provided by the client) for each submission. Submissions without a unique job-id or with a duplicate job-id will be rejected, client information including a valid client authorization code and optional digital signature.

The content and formatting data in the input stream preferably consists of one of the following, in the following order of appearance:

An XML body with XSL formatting information, as in the following example:

<content>

<body>

<!--- Not used until future XSL compliant --->

<!--- release --->

</body>

</content>

An empty body with DA-specific templates containing body. There is preferably DA-specific body-format combination for every DA option specified, as in the example:

<content>

<template datype=www>

<title>Ed McMahon says<var: susbt-name=name>

is a winner</title>

</template>

<template datype=e-mail daopt=html>

<title>Ed McMahon says<var: susbt-name=name>

is a winner</title>

</template>

<template datype=pager>

<var: subst-name=name>is a winner.

</template>

<template datype=IM daopt=ICQ>

<var: subst-name=name>is a winner.

See<var: subst-name=URL>

</template>

</content>

The submission metadata preferably comprises the following information:

Expiration Date & Time

Delivery Goal Date & Time

Default Priority

Number of Recipients

Global substitution data conforms to the specification as supplied in the following example of recipient substitution data. Global variable values are used during content variable substitution in cases when recipient-specific substitution value is provided.

<dadata type=IM>

<attr name=URL val=RangerURL>

</dadata>

The recipient information preferably includes the following data elements and may contain multiple instances of the following information:

a) DA Type: Delivery Agent Type—this is preferably either e-mail, pager or Instant Message (M). The system of the invention may alternatively provide for delivery over a combination of multiple delivery paths, including but not limited to, e-mail, instant message, and web-based.

b) DA Option: The Delivery Agent Option is specific for the DA Type and may be contain the following options:

E-mail:ASCII, HTML, AOL, MIME

IM: AOL, Yahoo, ICQ, MSN

Pager, via e-mail gateway, or native SMS.

c) DA Preference: Delivery Agent Preference will be numeric representing the order to attempt delivery by that mechanism.

d) DA-Specific Address: Delivery Agent Specific Address should contain information on how to deliver the message for the DA Type specified. The information may be represented as follows and conform to a DTD representing this data specified by Ranger:

| | |
|---|---|
| E-mail: | RFC-822 compliant address |
| Pager: | RFC-822 compliant address or |
| | Phone Number, PIN, and Paging System Information or |
| | HTTP |
| Postal: | Postal Standard Address-Format Addresses |
| Fax: | Phone Number |
| Voice: | Phone Number |

e) DA Preference: Only one DA Preference of any ranking is allowed per recipient.

f) Recipient Substitution Data: Data may be provided on a per-recipient basis for substitution into the message templates. Every substitution variable in the content must be defined by a substitution name value pair for each recipient or globally, or the recipient specific message will be rejected.

The following example illustrates the correct ordering of Recipient Information data elements.

<recipient id=xxxxxx>

<da-data>

<da rank=1>

<addr datype=e-mail daopt=html>

<address>nobody@nowhere.com

</address>

</addr>

</da>

<da rank=2>

<addr type=postal daopt=fedex-overnight>

<street1>xxxx</street1>

<street2>xxxx</street2>

<city>xxxx</city>

<state>xxxx</state>

. . . .

</addr>

</da>

<substdata>

<attr name=account val=12.34.5 />

<attr name=balance val=$1.23/>

</substdata>

</recipient>

MD5 checksums will be provided for the following sections:

Recipient

Content

Submission metadata

The Input Subsystem provides positive/negative feedback on acceptance of input.

The Data Upload Subsystem stores input data in MAILDIR format to a Network File System (NFS) for processing. The Data Upload Subsystem sends a message to the Parse, Validate & Load Subsystem that content has been received for delivery.

A Parse, Validate & Load Subsystem for taking the client input (a submission), parsing it, validating it, loading the data into a database, and notifying the Submission Router that it is ready for processing. The Parse, Validate & Load Subsystem accepts input from the Data Upload Subsystem. Data will is preferably contained in a single compressed file. The submission template table data may be stored as XML/XSL. An XSL style sheet is stored in the database as CLOBS. The data provided is preferably in one XML document. The following information should be supplied in the order delineated in the Input Requirements below for every unique submission to the Ranger system.

A client-unique, client-generated job-id and any optional attributes needed for submission data are included as metadata. Submissions without a unique job-id or with a duplicate job-id are rejected. The client information consists of a valid client authorization code and optional digital signature.

With respect to processing, the Parse, Validate & Load Subsystem is first notified by the Input Subsystem that a new submission has arrived for processing. The Parse, Validate & Load Subsystem then decompresses the received submission data file. The Parse, Validate & Load Subsystem then assigns a client-unique Submission ID to each validated submission. The Parse, Validate & Load Subsystem then opens the submission file and performs the following actions:

Read client id

Validate client id against the client tables

Validate that the submission was located in the proper directory for the submitter.

Validate that the job-id is unique.

Perform additional idempotency checks

Verify the component checksums are correct

Ensure that the XML submission components are well-formed and valid according to the DTD

Validation checks on recipient address fields for all delivery types. Rejected fields will be recorded in a failure table and processing will continue.

Failure of any of the above actions will result in the following:

Halt of processing

Logging of error(s)

Notification e-mail to the client of the problems with the submission

The customer's e-mail address is checked to ensure rfc822-compliant e-mail addresses.

The Parse, Validate & Load component updates submission database status column to reflect current status (valid & ready for load/rejected corrupt/rejected mal-formed, etc). In the case of successful validation, the client will be notified with the following information:

“Your submission has been received”

Message size

Customer ID

Job-ID (To be provided by the client)

Submission-ID

Checksum status

Accept/reject/statistical status

Scheduled assembly time

In the case of a failed validation the client is notified with the following information:

“Your submission has been received”

Message size

Customer #

Job-ID

Submission-ID

Checksum status

Accept/reject/statistical status

Error(s) found

The Parse, Validate & Load Subsystem inserts parsed submission data into the Submission Database, and then notifies the Submission Router of submission ready to be processed and scheduled for delivery. The Parse, Validate & Load Subsystem also stores the unparsed XML file in an Archive Database along with ClientID and SubmissionID data.

Submission Router

A Submission Router subsystem is preferably provided and is responsible for deciding which Delivery Scheduler will schedule processing for a particular submission. This decision is stored in a cache for future reference and in the submission database for future reference by other Submission Routers. The Submission Router communicates with the selected Delivery Scheduler and informs that Delivery Scheduler of it's responsibility for that submission. The Submission Router monitors the status (up, down and how busy) of the Delivery Scheduler to which it has assigned submissions. If a given Delivery Scheduler should become unavailable or otherwise fail, the Submission Router assigns another Delivery Scheduler to take over the process scheduling of the submission assigned to the failed Delivery Scheduler. Also in this case, the Submission Router will update it's cache and the submission database with the new Delivery Scheduler assignment information.

The Submission Router responds to requests from subsystems for information on which Delivery Scheduler has been assigned which submission. The Submission Router first checks it's own cache for the needed information. If the requested information is not found, the Submission Router queries the submission database for the needed information.

The Submission Router handles submitted data from the Out of Band subsystem relating incoming data to the appropriate submission and client information submitting this information to the tracking daemon for storage in the tracking database.

The Submission Router accepts data from a recipient's message handlers and/or domains indicating whether a message has been successfully received.

With respect to inputs, the Submission Router accepts submission-ready-for-processing information from the Parse and Validate Subsystem. The Submission Router accepts message status data and forward it to the Tracking Subsystem for all Delivery Agents. The Submission Router accepts status information from the Delivery Scheduler to which it has assigned submissions. The Submission Router accepts requests for status information from the Administrative Subsystem. The Submission Router accepts requests for Delivery Scheduler information from all Subsystems. The Submission Router accepts requested data from the Submission Database.

The Submission Router processes incoming data from the Out of Band and Web Tracking Agents subsystems. Received data is related to the appropriate message, submission and client and submitted to the Delivery Scheduler, which submits the data to the Tracking Subsystem for storage. The Submission Router requests, accepts, and processes data from the submission database as needed.

All code in the Submission Router preferably makes use of two Global Variables:

GlobalDebugLevel: This is used to determine the debug level at which the system is currently running. It enables libraries to use the same debug level without providing additional function calls.

GlobalShutdown: This is used by all threads to determine if it is shutdown time. This facilitates processing, since there is no good signaling mechanism between threads.

The Submission Router sends submission information to a selected Delivery Scheduler. The Submission Router also sends requests for data to the submission database.

The Submission Router accepts a failure message for each instance in a submission where a message cannot be delivered to the intended recipient, a/k/a, a “bounced” message. Sources for the failure message may be any of the Delivery Agent Subsystems or the Out of Band (OOB) Subsystem

The failure message for each bounced message may include the following elements:

| | | |
|---|---|---|
| a) | DATESTAMP-UTC | date & time in UTC format |
| b) | RecipientAddress | address of intended recipient (address of failed |
| | | delivery), could be e-mail, IM, pager, fax, etc. |
| c) | BounceError | error condition causing bounce |
| d) | Action | action taken in response to bounce, if any |
| e) | Reason | why the action was taken |

ExtraComments
Delivery Agent

| | | |
|---|---|---|
| h) | MessageID | Ranger-assigned message ID |
| i) | SubmissionID | Ranger-assigned submission ID |
| j) | RecipientID | Ranger-assigned recipient ID |
| k) | SubsystemID | identifier of subsystem originating entry (EDA, |
| | | IMDA, OOB, etc.) |

An example of such a failure message is the following:

571 nosuchuser@nosuchdomain.com we do not relay

The Submission Router will provide requested status information to the Admin Subsystem.

Based on return information from a recipient's message server and/or domain, the Submission Router will inform the Delivery Scheduler of the success or failure of its delivery attempts.

Tracking data is sent to the Tracking Subsystem via the Delivery Scheduler.

Delivery Scheduler

Delivery Schedulers are provided for processing submissions received from a Submission Router. The Delivery Scheduler initiates assembly and delivery as required. The Delivery Scheduler keeps track of the assembly status for each message of a particular submission that is scheduled for future delivery. The Delivery Scheduler preferably processes submissions immediately upon receipt from a submission router. The Delivery Scheduler handles an assigned submission in its entirety.

When the Delivery Scheduler is notified by a submission router that it is responsible for a submission, it will spawn a new thread, retrieve the necessary submission data from the submission database, build it's own internal data structures and initiate communication with an Assembly Engine. The Delivery Scheduler will be notified by the Submission Router when a recipient has received their message and no more attempts at delivery should be made. The Delivery Scheduler is also notified by the Submission Router when delivery of a message to a recipient has failed. The Delivery Scheduler will then attempt delivery via another delivery method if one is available.

The Delivery Scheduler is able to retrieve desired alternative delivery means for the recipient. That is, the Delivery Scheduler retrieves the next Delivery Agent type from the list of prioritized, alternate addresses/delivery methods specified in the submitted data for this recipient.

The Delivery Scheduler maintains message status in a database. In this respect, should the Delivery Scheduler fail, another Delivery Scheduler process can pick up processing from where the original Delivery Scheduler stopped.

The Delivery Scheduler monitors the DA Stats cache to keep track of domains that are not currently accepting messages and not attempt assembly/delivery of messages for those domains.

When the Delivery Scheduler communicates with an Assembly Engine it will tell the Assembly Engine whether the assembled message is to be passed to a DA for delivery immediately or be stored in the Assembled Messages data-store for pre-assembled message delivery at a later time.

The Delivery Scheduler will track a submission in its database whether or not a message has been pre-assembled for future delivery.

The Delivery Scheduler submits a list (size is configurable) of recipients (i.e. 1000) for which messages will need to be assembled to a given Assembly Engine. Each such assembled list is designated as a chunk.

The Delivery Scheduler places submissions not scheduled for immediate delivery into a special timer queue. The messages in the submission are scheduled and pre-assembled. The data structure holding the submission linked list will then be deleted. When the time comes to deliver, the submission the database will be queried and the submission linked list will be rebuilt. The actual delivery of the messages will then be initiated.

The Delivery Scheduler may be provided with functionality to divide a submission chunk into geographic chunks based on best delivery location (remote sites running the system of the invention). This division may be based upon, e.g.:

Recipient's zip code

Recipient's city

Recipient's state

Recipient's area code

The Delivery Scheduler is the intermediary between other subsystems and the Tracking Subsystem. That is, other subsystems communicate with the Tracking Subsystem through the Delivery Scheduler.

The Delivery Scheduler will accept submission information from a Submission Router. Information received will include:

SubmissionID

Whether the submission will be scheduled for immediate delivery or for pre-assembly for later processing

The Delivery Scheduler also accepts message update information from a Submission Router. Information received may include:

Notification of message received by the recipient

Notification of failed message delivery to the recipient

As part of its configuration information, the Delivery Scheduler accepts the following data from the submission database:

host

ports

number of threads

chunk size

message cache flush timing

The Delivery Scheduler must accept a message from the Assembly Engine, which notifies the assembly scheduler that some messages were not assembled for a given batch. The communication is preferably synchronous, and does not return until the Assembly Engine has handled all the submitted messages and has returned a status (success/failure/queued).

The Delivery Scheduler also accepts input from the DA Stats Cache, and accepts data from Web Tracking Agents.

The Delivery Scheduler sets up and stores the status of each message in a submission. The data should be cached and periodically (timing will be configurable) dumped to a database.

Upon receipt of a submission to process, the Delivery Scheduler will spawn a new thread, retrieve all submission information from the submission database and build it's own internal data structures.

When the Delivery Scheduler receives notification from the Submission Router that a message has been received, the Delivery Scheduler updates its records and database entries accordingly.

When the Deliver Scheduler receives notification from the Submission Router that a message delivery attempt has failed the Delivery Scheduler will collect the information necessary to attempt delivery via another delivery method. This relates to the “Rollover” feature, discussed in further detail elsewhere herein.

The Delivery Scheduler maintains message status in a database allowing another Delivery Scheduler to pick up processing where the original Delivery Scheduler left off should it fail.

The Delivery Scheduler monitors the DA Stats cache to keep track of domains that are not currently accepting messages.

The Delivery Scheduler tracks whether or not a message has been pre-assembled for future delivery. This information is stored in a database for possible processing by another Delivery Scheduler.

The Delivery Scheduler places submissions not scheduled for immediate delivery into a special timer queue for future processing. Messages scheduled for future processing will be assigned to an assembly engine for pre-assembly.

The Delivery Scheduler responds (ACK/NAK) to Submission Router inputs.

The Delivery Scheduler requests submission data (based on received submissionID) from the Submission Database.

The Delivery Scheduler sends messages to a selected Assembly Engine for assembly. The information preferably includes:

A flag to tell the assembly engine whether or not to immediately attempt message delivery or to store the assemble message in the Assembled Message data store for future delivery.

A list of recipients and message information for those recipients for messages to be assembled. The size of the list will be configurable.

Data elements to be included in this information are:

SubmissionID

RecipientIDs

Delivery Methods

Delivery schedule (Immediate or Delayed to specified time)

Assembly Engine Subsystem

An Assembly Engine is provided for assembling messages as assigned by a Delivery Scheduler for either immediate delivery or for assembly for future delivery. The Assembly Engine uses a message template, message style sheet, and recipient information to assemble a customized message specifically for the assigned recipient.

The Delivery Scheduler detailing assignments to an Assembly Engine tells the Assembly Engine to either build the messages for immediate delivery or to store in the Assembled Message data store. If the messages are to be built for immediate delivery the assigning Delivery Scheduler will tell the Assembly Engine which DA to pass the assembled messages to.

The Delivery Scheduler detailing assignments to an Assembly Engine will tell the Assembly Engine if the messages assigned for processing have been pre-assembled. If the message has been pre-assembled the Assembly Engine will read the message from the Assembled Message data store. The Delivery Scheduler detailing assignments to an Assembly Engine will pass a list of messages for assembly. The Assembly Engine will retrieve the messages template, message style sheet and recipient information from the Submission Database.

The Assembly Engine is limited to variable substitution, not content creation from distinct categories. There is no limit on the number of substituted variables, or the size of the substituted variables. Variables may not be recursively substituted.

The Assembly Engine creates messages formatted for each recipient based on their DA preferences.

Should a decision be made by the Delivery Scheduler to rollover delivery to another delivery method for a particular message, the Assembly Engine will rebuild the message as appropriate for the new delivery method based on recipient preferences.

Rollover is the process in which a message is regenerated and scheduled for delivery utilizing an alternate DA, if one exists, when delivery utilizing a more-preferred DA has not succeeded. Reasons for unsuccessful delivery include:

Failure to deliver the message using the preferred DA

Expiration arrived on preferred DA

The DAs which are used for transmitting messages to a particular recipient can be analyzed on a recipient basis to determine which are statistically most successful. Once this is determined for a recipient, it future delivery agent choices can be influenced based on past performance.

The Assembly Engine may support the following delivery formats:

E-mail/ASCII

E-Mail/MIME alternate (text/plain; text/html)

E-mail/HTML

E-mail/AOL

E-mail/Pager (Pager/RFC822)

IM/AOL (TOC protocol)

IM/ICQ

IM/Yahoo

IM/MSN

The Assembly Engine is preferably configured not to delay submissions due to any behavior on the part of other submissions (e.g. very long assembly time, down domains, etc.).

The number of concurrent Assembly Engines is only limited by resource availability. When a resource limit has been reached, no more Assembly Engines will be started, and an SNMP trap will be generated.

The Assembly Engine merges the components of a message from global and recipient submission data into a message prepared and formatted for delivery using XSL. The assembly engine is preferably able to generate the multi-part mime and base-64 encoding of messages.

The Assembly Engine preferably delivers assembled messages to the DA via QMQP+ based on message priority if the message should be immediately delivered. If the primary DA host is unavailable or the message should be held for later delivery, then the message will be stored in the Assembled Message data store. If the message is not assembled due to it's domain mail server(s) being down the Assembly Engine will so notify the Delivery Scheduler.

After successful assembly, the status field for the message in the Submission Database is updated to “Assembled” in the message table of the database.

The Assembly Engine reports all message tracking information to the Delivery Scheduler. Tracking status will include, but not be limited to, the following categories:

Received for assembly

Assembled

Not Assembled

Reason Not Assembled

Sent via DA/Delivered

Sent via DA/Queued

Sent via DA/Rejected

Sent to Assembled Message data store

Messages assembled by the Assembly Engine contain subscribe/unsubscribe information provided by each Ranger client. This information may be used in a normal variable substitution. Subscribe/unsubscribe information should be present in every message delivered by the system of the invention.

The Assembly Engine is preferably able to convert XML to HTML, ASCII, AOL, or any other supported format as needed.

The Assembly Engine receives the following input from a Delivery Scheduler:

MessageID

SubmissionID

RecipientIDs

Delivery_Type Immediate/Pre-Assemble—Tells the Assembly Engine whether or not the messages assigned are to be passed immediately to a DA for delivery or to the Assembled Message data store.

PreAssembled True/False—Tells the Assembly Engine whether or not the messages assigned have already been assembled

The Assembly Engine receives pre-assembled messages from the Assembled Message data store; receives input from the Domain Stats Cache; and receives message assembly data from the Submission Database. The Assembly Engine also requests and receives blacklisted addresses from the Blacklist. The Assembly Engine will refrain from building messages for recipients whose addresses and/or domains appear in the Blacklist.

The Assembly Engine assembles customized messages using a message template, message style sheet and recipient information.

The Assembly Engine will include Time Zone Lookup functionality such that it can determine a recipient's Time Zone from standard US Postal Service Zip Code data.

The Assembly Engine sends assembled messages to the assigned (by the Delivery Scheduler) Delivery Agent for messages delivery. The Assembly Engine should supply the VERP and Expiration Date to the Delivery Agent.

The Assembly Engine further sends assembled messages to the Assembled Message data store as directed by the assigning Delivery Scheduler.

The Assembly Engine requests message assembly data from the Submission Database based on information received from the assigning Delivery Scheduler. Those data include, but are not limited to, the following:

Content

DA

Specific XSL Formatting Information

Global substitution data

Recipient preferences

Recipient substitution data

The Assembly Engine output to the Delivery Scheduler includes location or time zone information to enable the Delivery Scheduler to calculate the appropriate delivery time for a given recipient.

The Assembly Engine outputs to the Tracking Subsystem a list of blacklisted recipients for whom messages were not built.

Delivery Agent Subsystems

E-Mail Delivery Agent Subsystem

A collection of E-Mail Delivery Agent Substems (EDAs) are provided for delivering large volumes of e-mail messages (e.g., in excess of million e-mail messages) per hour. With an estimated size of 15 KB/message, the system requires approximately 42 Mbps outbound bandwidth.

The EDA will attempt immediate delivery and queue the message for further attempts if immediate delivery is not possible but no hard failure is encountered.

An EDA preferably comprises the following elements:

Mail Transport Agent

Local mail queue

Mechanism to access remote domain mailers' readiness status

Mechanism to update the tracking database via the Submission Router

The EDAs should be able to accommodate messages of varying priorities. This can be done on a per-EDA submission, or could be done by having the Delivery Scheduler/Assembly Engine send messages to machines, which are specific to various queue priorities.

EDAs receive messages via network connections from the Assembly Engine for immediate delivery, as well as for delivery of pre-assembled messages; the goal is to reduce disk transfer to speed delivery where possible. This may be done via QMQP+.

Each physical EDA machine will have one or more EDA processes with multiple delivery threads; the number of processes and threads is determined empirically to find the fastest combination; each process must listen on a unique socket number for incoming connections.

Each machine running an EDA process preferably has the Domain stats cache available in memory. Each EDA process will in turn have many EDA delivery threads, which will access that information from memory. This requires that each EDA machine have a separate thread running to fetch stats cache data from the database and load the memory resource; this process will use a “double buffering” approach to store data into a write-only portion while EDA processes access the read-only portion; a mutex is used to indicate which portion is readable and which is write-able.

Each EDA gets content information in its final format in order to reduce processing requirements on the EDA; this includes message headers (including VERP and Expiration), message body, variables substituted, and formatted as ASCII, HTML, or multi-part MIME as appropriate to the recipient's profile.

The DA uses Variable Envelope Return Paths (VERPs) to set a message-unique and recipient-unique envelope “From” field; this will be used by “OOB Handlers” to determine the actual recipient if mail bounces back from remote site. It will also be used by Web Agents for tracking.

For each hard-rejected message, the EDA will send a delivery failure message to the Submission Router and/or the Assembly Engine, so that it can direct the appropriate Delivery Scheduler to identify an alternative delivery means for the recipient, if an alternative delivery means has been specified in the submission.

An EDA receives messages from an assembly engine via QMQP+ protocol. Messages are preferably transmitted to EDAs via a Load Balancer to ensure the receiving EDA can accept the transmission. Once a message is received from an Assembly Engine its life should be tracked.

Each EDA will get the address in its normal “user@dom.ain” format. The EDA will attempt to resolve this domain to an available IP address by calling the Domain stats. If the domain is not in the DNS cache, the EDA will have to attempt domain name resolution to the best Mx or A record itself.

EDAs receive intelligence about the availability and speed of remote domain mail transport agents from the Domain Stats cache.

The EDA will attempt immediate delivery unless the “Domain Stats” entry for the target has marked it “Down” or “Administratively Down.” The EDA will first attempt immediate delivery before committing to disk, to improve performance. It should not acknowledge the QMQP+ submission until it has completed one of the following operations:

A) Successfully delivered the message and updated tracking information through the Delivery Scheduler or the Submission Router

B) Updated tracking information through the Delivery Scheduler or the Submission Router after the receipt of a hard failure (Permanent rejection by a remote MTA)

C) Committed a message to SAN disk queue and updated tracking information after the receipt of a soft failure (Transient deferral)

Mail which cannot be delivered immediately, (“Domain Stats” has marked the target “Down/AdmDown”) will be queued for later delivery attempts by the EDA.

The EDA uses “Domain Stats” information to decide whether to send mail immediately or queue, and how long it should wait for remote connection and greeting, number of simultaneous queues allowed, etc.

The EDA will delete a message from it's queue when the message's expiration time passes. Expiration date/time will be indicated by a message “X-” header set by the Assembly Engine. It will also send tracking data to the Submission Router.

The EDA preferably never generates a bounce message, which might slow down other subsystems. The EDA tracks the message, but the message content of the failed deliveries should not be included.

The EDA will time the delivery and calculate the speed of connection to the remote MTA (bytes/seconds); this should be added to the tracking database for the domain.

If an EDA cannot make a connection to a target, the EDA will attempt to re-deliver the message, based on Qmail's existing exponential backoff algorithm.

The E-mail Delivery Agent updates tracking information by responding to the Assembly Engine or by sending asynchronous updates to the Submission Router.

Tracking updates are preferably as specific as possible, so as to guide subsequent attempts; these are based on SMTP reply codes in RFC-821; status values include Success, or Soft/Hard errors. Soft/Hard status will be based on the SMTP reply code, either 4yz for Transient errors (Soft) or 5yz for Permanent errors (Hard). Example database table MessageStatusKey status symbols include: EDA_250_Success, EDA_421_ServiceNotAvailable, EDA_Hard_450_MailboxUnavailable, EDA_Hard_550_MailboxUnavailable, EDA_Hard_553_MailboxNameNotAllowed. An EDASoftUnknownReason and an EDAHardUnknownReason may be needed as new ways for mail to fail are discovered.

421 <domain>Service not available, closing transmission channel

450 Requested mail action not taken: mailbox unavailable [e.g. mailbox busy]

451 Requested action aborted; local error in processing

452 Requested action not taken; insufficient system storage

455 temporarily unable to accommodate one or more parameters [RFC-1869]

500 Syntax error, command unrecognized

501 Syntax error in parameters or arguments

502 Command not implemented

503 Bad sequence of commands

504 Command parameter not implemented

550 Requested action not taken: mailbox unavailable

551 User not local; please try <forward-path>

552 Requested mail action aborted; exceeded storage allocation

553 Requested action not taken: mailbox name not allowed [including no-relaying]

554 Transaction failed

555 does not recognize or cannot implement one or more of the parameters [RFC-1869]

The EDA may need to interpret SMTP transient (4xx) errors as hard failures if the transient error would significantly slow delivery.

The EDA tracks SMTP 5xx errors to capture their numeric code and server-specific text string.

The EDA will enable an Administrator of the system of the invention to start, pause, or stop a message queue at any time.

The EDA stores the mail queue on SAN disk so the queue may be made available to other EDAs in the event of EDA failure.

The EDA updates the tracking database via the Assembly Engine or the Delivery Scheduler with success, failure or attempted delivery information, the identity of the machine that took the action, speed of the connection, and timestamp.

The EDA preferably includes functionality to deliver messages to remote MTAs.

The EDA sends requests for domain information to the Domain Stats cache/database.

The EDA will generate a failure message for each instance in a submission where a message cannot be delivered to the intended recipient, a/k/a, a “rejected” message. The EDA will pass the VERP back to the Assembly Engine or to the Submission Router.

Instant Messenger Delivery Subsystem

An Instant Messenger (IM) delivery subsystem is provided for delivering IM messages to recipients via AOL's Instant Messenger Service. The messages should be delivered quickly, and the IM delivery subsystem should allow for an early decision as to whether or not to roll delivery of the message over to another delivery method.

AOL Instant Messenger (AIM) and ICQ may both be supported. AIM uses the OSCAR protocol. ICQ uses the ICQ protocol.

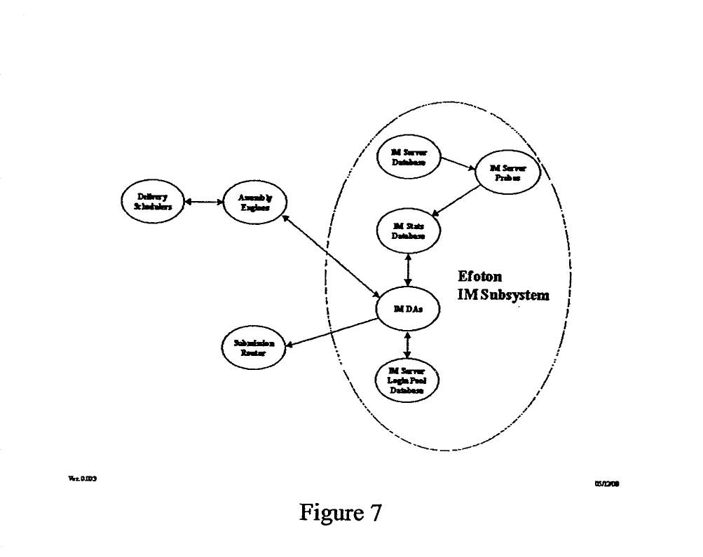

FIG. 7 shows the modules that comprise the IM Subsystem.

IM Delivery Agents

IM Delivery Agents are provided for contacting IM servers/recipients and delivering IM messages. For each undelivered message, the IMDA will send a delivery failure message to the Delivery Scheduler, so that the Delivery Scheduler may identify an alternative delivery means for the recipient, if an alternative delivery means has been specified in the submission. The IMDAs will support 5 thousand messages per hour, collectively.

The IMDA accepts input from an assembly engine. The IMDA then sends the message to the recipient via an IM server. Input elements may include any or all of the following:

VERP—message ID

ImID—Screenname of the recipient

ImMessage—URL/text

TTL—time to live for the message

CRC—circular redundancy check for the message

ImType

ClientID

SubmissionID

RecipientID

The IMDA will accept IM server login account information from the IM server login pool database based on InUse status (multiple logins from a single account are not allowed so if the InUse status is “TRUE” the next login account for that ImType will be needed).

Login—login id for imType

Password—password for login

InUse—yes/no

The IMDA accepts module status requests and start/stop requests from the Admin module.

The IMDA accepts input from the IM Stats database. The Delivery Scheduler periodically requests IM server(s) status and associated connectivity speed to aid in determining what IM messages can/cannot be delivered (allows for early rollover decision) and what server to use.

When delivering messages to an IM server, an IMDA will request login information based on ImType from the IM Server Login Pool database and login into the assigned IM server in preparation for delivering IM messages. If the InUse status is “IN USE” the IMDA will request another login for ImType.

The IMDA reports module status when requested. Status information includes, e.g., the following data:

Up/down

Messages scheduled

Threads running

Servers connected to

An IMDA reports to a IM Server Login Pool Database when use of account information is complete.

The IMDA reports delivery-to-server success/failure to the Submission Router or the Assembly Engine.

The IMDA updates InUse based on input from an IM delivery agent when the delivery agent is finished using the account.

The IMDA requests IM server(s) status and connectivity speeds for ImType from the IM Stats data store.

If a message's time to live has expired, it will not attempt delivery of the message and will report the message as not delivered due to delivery time expiration.

The IMDA reports module status when requested, including:

Up/down

Messages scheduled

If a message is undeliverable, the IMDA reports delivery failure to the Submission Router.

The IMDA sends login and password information to an IM server.

The IMDA will send message(s) to recipient. Such messages include, e.g., the following data:

ImID

ImMessage

The IMDA sends message tracking data to the Submission Router or the Assembly Engine. Such data includes, e.g.:

VERP

IMID

IM type

Date-time-group if available

Speed of user's connectivity

TTL

URL/message

Delivered/not delivered

Delivery class

The IMDA sends account-no-longer-needed status to the IM Server Login Pool database; sends module status to Admin Subsystem; updates the IM Server Login Pool database when IM login account information is released; sends “In Use” data to the IM Server Login Pool database; and sends ACK/NAK or data to Admin Subsystem in response to requests as appropriate.

The IMDA generates a failure message for each instance in a submission where a message cannot be delivered to the intended recipient, a/k/a, a “rejected” message. This can be done using the same synchronous mechanism used by the Electronic Mail delivery Agent (EDA).

The failure message for each rejected message may include the following elements:

| | | |
|---|---|---|
| a) | DATESTAMP-UTC | date & time in UTC format |
| b) | RecipientAddress | address of intended recipient (address of failed |
| | | delivery), could be e-mail, IM, pager, fax, etc. |
| c) | BounceError | error condition causing bounce |
| d) | Action | action taken in response to bounce, if any |
| e) | Reason | why the action was taken |
| f) | Delivery Agent | |
| g) | MessageID | Ranger-assigned message ID |
| h) | SubmissionID | Ranger-assigned submission ID |
| i) | RecipientID | Ranger-assigned recipient ID |
| j) | SubsystemID | identifier of subsystem originating entry (EDA, |
| | | IMDA, OOB, etc.) |

The IMDA may store data on IM server status that will facilitate the delivery of IM messages and decisions, from an IM standpoint, regarding delivery method roll.

The IMDA may be configured to accept the following data from IM server probe(s):

ImType

ServerID

ServerIP

ServerStatus

RTT

ServerProbeTime—date time group of last probe to this server

The IMDA may be configured to accept requests for the following server data from the IM Delivery Scheduler:

ImType

ServerID

ServerIP

ServerStatus

RTT

ServerProbeTime

The IMDA preferably responds to requests for server availability information from the Delivery Scheduler.

An IM server database is provided for storing data on known IM servers. The IM Server Database will accept IM server data input from the Administration module. These data will identify IM servers by type so that IMDAs will know about the server. Such data include, e.g.:

ImType

ServerID

ServerIP

The IM Server Database responds to requests for listings of known IM servers by ImType.

Web Delivery Agents

Web Delivery Agents (WAGs) are provided for delivering message content to a recipient via the recipient's web browser. Each WAG preferably includes the following elements:

Web Server

Dynamic page-generation logic

Database access functions

Each WAG preferably handles the following types of http requests:

‘invisible’ image requests used for tracking HTML message openings

‘click-throughs’ for content not hosted by Ranger from URLs embedded in HTML messages

user requests for content (page view requests from HTML messages) from Instant Message clients

Upon receipt of any request, a WAG will capture & record the following client request variables:

HTTP_REFERER

REQUEST_METHOD

QUERY_STRING

REMOTE_USER

HTTP_USER_AGENT

The WAG will extract the following information from a banner ad URL:

LinkID

MessageID

The VERP will be present in the HTTP URL. All information necessary in processing and tracking requests should be available by knowing the VERP.

The WAG will decode the VERP (embedded with every page-view, invisible GIF and click-through (remote URL) request) to extract the MessageID of the outbound message from which this request originated, as well as the customer (Client) ID.

The WAG checks the Submission.Expiration Time of the message, and take one of the following actions:

If the request is not valid, the request will be refused with a HTTP 404 error.

If the Message has expired, a page will be served stating that the data is no longer available. Customers will provide a single static page for expired message pages. If they do not provide one a generic Ranger expiration page will be displayed.

The WAG will process page-view requests when the Submission.Expiration Time in the message table of the corresponding DB is greater than today's date and request reception hen the Submission Expiration Time is in the future.

The WAG creates and delivers an HTML page to the requesting client browser when a request containing an un-expired MessageID for a valid CustomerID is received by any of the following methods:

A) Querying the corresponding database for the following information:

| | |
|---|---|
| Submission.XML-content. | |
| Substitution.Var-name | 0-n occurrences |
| Substitution.value | 0-n occurrences |
| Message.xsl-template | |

B) Substituting the values for var-name wherever names occur in the Submission.XSL-template

C) Formatting the SubmissionContent.Data using the Message.xsl-template

The WAG will verify the LinkID, MessageID combination obtained from a banner ad URL to make sure that it is legitimate for the particular ClientID.

The WAG will embed the message signature decoded in the request back into each page and ‘invisible image’ as it is delivered.

WAGs preferably support non-nested HTML tables. WAGs preferably further support the following types of ads:

banner ads up to 400 * 200 pixels

anchor or spot ads of up to 200 * 120 pixels.

For messages with a Submission Expiration Time greater than the current time and date (i.e., the expiration time is in the future), the WAG will provide page request and read acknowledgements to the Delivery Router, which will pass the data to the Tracking Subsystem.. The WAG will not provide this information for page requests and read acknowledgements when the Submission Expiration Time has already passed.

For messages with a Submission Expiration Time greater than the current time and date (i.e., the expiration time is in the future), the WAG may send the click-through information to the Tracking Subsystem. At a minimum, the following information should be included:

VERP

Link-ID

Any information the Ranger system encodes on the URL

Date and Time Stamp of the click

Type of request

The WAG should not provide this information for page requests and read acknowledgements when the Submission Expiration Time has already passed.

Probe Subsystems

MTA Probe Subsystem

An MTA Probe (MTAP) is preferably provided for calculating delivery time statistics. The probe gathers the set of target domains from the domain database table; this may be a list of the top 1000 most popular domains. The MTAP will probe the domain's best available MX or A record servers and determine TCP connection and SMTP server greeting time.

The MTAP computes statistics from the samples and makes these available to the Assembly Engine, Email Delivery Agents, and other subsystems by storing them in the domain database table for access by the Domain Stats Cache API.

Multiple geographically disbursed MTA Probes (e.g., the probe will provide it's own identity in the statistics so we can determine which is “closest” to the target domain MTAs) are preferably supported.

At startup, the MTAP will get the maximum_age of samples to retain, the probe_interval, number_of_threads, and mx_sample_age to employ from the configuration database table config. Also at startup, the MTAP will retrieve the list of target DNS domain names, e.g., with “SELECT domain_name FROM domain”. (This table will be populated periodically by an external process which is outside the scope of this subsystem.)

For each domain, the MTAP will resolve the corresponding DNS Mx and A records. (the “dnscache” caching DNS resolver may be used on the MTAP host for speed; it may query a full DNS server for information not in its cache). For each set of domain MX/A records, the MTAP will sort and group them by preference: lowest MX value first, then higher MX, and finally A records.

For each domain, the MTAP connects to each address in the most preferred group and measures its TCP connection speed and time to get the SMTP greeting. If none of the most preferred group of addresses are available, the MTAP will try the next preferred group, and so on until it runs out of records. If none of the addresses in any preference are available, the domain will be marked “down”. The MTAP stores the sample information into the mxsample database table.

The MTAP can cause a database trigger to be executed which will clean old samples from the mxsample table. The MTAP trigger will cause the following statistics to be recalculated in the mx table:

connect_min

connect_max,

connect_sum,

connect_average,

connect_deviation,

hello_min,

hello_max,

hello_sum

hello_average,

hello_deviation,

success_coun,

failure_count,

status_id,

updated_dt.

The status indicates whether the particular MX (or A) host is up or down.

The MTAP trigger will cause the following statistics to be recalculated in the domain table:

status_id

mxhosts_min

mxhosts_max

mxhosts_average

wentdown_dt

updated_dt.

Here, the status is the overall accessibility of the domain; it should only become “down” if all servers at all preferences for the domain are unavailable. If a domain is detected down, the MTAP will again probe its MX hosts a few times at a smaller interval to ensure that the first probe was not an anomaly. Only after several such retry probes fail will it mark it “down” and record the time we noticed it unavailable.

The mxsamples table stores a finite number of samples for each “mx” host by its IP address, trimmed by a trigger and stored-procedure as new samples are entered.

Each IP address in the mx table will have its connect and hello time statistics calculated from the mxsamples entries by a trigger and stored-procedure as new samples are entered. The status of the mxaddress will be updated likewise.

The domain table will have its connect and hello average and standard deviation statistics recalculated from a trigger and stored-procedure. The status of the overall domain will be updated likewise.

The domain table will have calculated via trigger the minimum, maximum, and average number of probed MX hosts for the current collection of mxsamples.

The time all the MX hosts for a domain have been detected as unavailable (“down”) will be available as domain.wentdown_dt.

The domain states include: “up”, “down”, and “administratively down”. The “down” state means that there are no available MTAs for the specified domain at any preference level. An “up” domain means that there is at least one available MTA for the specified domain. The domain-probe will not change the state of a domain marked as “administratively down”.

Instant Message (IM) Probe Subsystem

IM Server Probe

The IM Server Probe is provided for probing IM servers for availability and determining/gathering connectivity speed information. The IM Server Probe accepts the following input from IM Server database:

ImType

ServerID

ServerIP

The IM Server Probe will collect the following availability/accessibility and connectivity information for each IM server.

ServerStatus

RTT

ServerProbeTime

The IMP Server Probe accepts status and start/stop requests from the Administrative Subsystem. The IM Server Probe accept the following configuration information from the Configuration Database.

Probe timing

Periodicity of server probes

As set forth above, the IM Server Probe periodically probes known (from the IM Server database) IM servers for availability/accessibility status and connectivity speed information (RTT). The IM Server Probe will insert/update the following availability and connectivity status information in the IM Stats database:

ImType

a ServerID

ServerIP

ServerStatus

RTT

ServerProbeTime

The IM Server Probe will request lists of servers to probe from IM server database. Data to be requested will include the following:

IM_type

ServerID

ServerIP

The IM Server Probe will populate the IM Stats Database with the following probe results:

ImType

ServerID

ServerIP

ServerStatus

RTT

ServerProbeTime

The IM Server Probe will send subsystem status to the Administrative Subsystem when requested.

Out of Band (OOB) Handler Subsystem

An OOB Subsystem is provided for handling responses from remote systems that are not immediate and cannot be handled by the Delivery Agents themselves.

VERP information is the preferred information to base OOB logging on as it provides the best information. (Additional discussion of VERP may be found in Appendix A, entitled “Memo: VERP Versus Message ID Revision: 2.0”, which is incorporated by reference as if fully recited herein.) Any bounces returned by remote MTAs are processed by the OOB Handler Subsystem. Any replies from Recipients will also be processed. The first 2K of any reply or auto-responder will be saved in the database. Any auto-responder replies will be processed, logged and discarded.

Bounce messages from Mail Transfer Agents (MTA) due to fatal and transient errors that occur when trying to deliver e-mail are processed. These typically come from mail-daemon and postmaster accounts on remote machines.

The OOB extracts VERP information if possible; extracts DSN information if possible; and extracts the “To:” header information to see if it corresponds to the customer and submission unique “From:”, “Reply-To:”, and “Errors-To:” headers. The OOB will attempt to parse and automatically handle replies by the recipient of the message.

The OOB will generate a failure message for each instance in a submission where a message cannot be delivered to the intended recipient, a/k/a, a “bounced” message.

The failure message for each bounced message may include the following elements:

a) DATESTAMP-UTC date & time in UTC format

| | | |
|---|---|---|
| b) | RecipientAddress | address of intended recipient (address of failed |
| | | delivery), could be e-mail, IM, pager, fax, etc. |
| c) | BounceError | error condition causing bounce |
| d) | Action | action taken in response to bounce, if any |
| e) | Reason | why the action was taken |
| f) | ExtraComments | |
| g) | Delivery Agent | |
| h) | MessageID | Ranger-assigned message ID |
| i) | SubmissionID | Ranger-assigned submission ID |
| i) | RecipientID | Ranger-assigned recipient ID |
| k) | SubsystemID | identifier of subsystem originating entry (EDA, |
| | | IMDA, OOB, etc.) |

An example of such a failure message is the following:

571 nosuchuser@nosuchdomain.com we do not relay

Billing Subsystem

A Billing Subsystem is provided for receiving, storing and calculating data necessary to charge users/clients of the system of the invention for the services provided by the system. Information about each submission and all messages is recorded and made available to the billing system on a per-submission basis.

The information in the table below should be reported to the billing system in XML format and adhere to the DTD defined for billing. The Billing System is provided with the following for each submission:

Client name

Client Employee providing the input as a submission to Ranger

The date and time of input

The date and time of assembly

The date and time that delivery started

The date and time that delivery finished

The number of recipients in the submission input per primary Delivery Agent and summation of all recipients

The number of successful message and failed message deliveries

The number of rollovers attempted, successful and failed

The average and total message volume in Megabytes.

Administrative Subsystem

An Administrative Subsystem is provided to allow administrators of the system to perform tasks such as user account administration and starting and stopping of subsystems. The slew Administrative Subsystem user interface is preferably web-based and uses SSL where possible. The Administrative Subsystem is not meant to replace Network and System monitoring, which can be done by third party network monitoring packages such as HP OpenView.

The Administrative Subsystem preferably uses a common Authentication Data Store for the Client Administration, User Input System, and Client Reporting.

Access to system user account information may be provided for both internal users and client users. Access to all subsystems and databases may be required. Such access may be direct or through a supporting process such as the Watchdog.

The user interface should allow each of the major systems to be started, stopped, and restarted. Multiple versions of each sub-system may be running for redundancy, load balancing and scaling. It should be possible to cleanly shut down all instances of a given subsystem or specific instances of a sub-system for maintenance (or any other reason). Administrators should be able to shut down a sub-system without causing the overall system to fail.

The Administrative Subsystem should enable a System Administrator ability to shut off a message queue on the MTA Subsystem.

The Administrative Subsystem should be configured to receive information from a web client, from Sun Solaris™ commands and utilities, from the Logging Subsystem, and/or from state information stored on NFS. An Administrator should be able to view the status of each subsystem and its host machine.

An Administrator is provided with the ability to initiate an action on an Ranger subsystem. Actions include, but may not be limited to, the following:

Stop

Start

Restart

Read-Config

Increase logging level/verboseness

Stop logging

Determine status/state

Administrative Subsystem output should include, but not be limited to, the success or failure for all attempted operations and detailed failure information for failures that occur. Failure information should include, but not be limited to, the following:

Error message

Subsystem(s) affected

ProcessID(s) (PID)

Database(s) involved

Log entries of all actions should include the following information:

Date and time stamp

Subsystem(s) altered on a per machine basis

Processes altered on a per machine basis

Username of individual making changes

The Administrative Subsystem includes Submission Control functionality for providing administrators with control over client submissions. Inputs to Submission Control include: user authentication data, all client tables from the database all submission tables from the database, and a persistent data store of recipient information across all submissions. An Administrator with write access permission is able to perform the following tasks:

Stop the assembly of a submission

Resume the assembly of a submission

Prevent delivery of a submission not yet started

Allow delivery of a submission being held

An Administrator is able to prevent delivery across all submissions to specific users and/or specific domains.

For all submission actions, whatever their state, appropriate Database tables will be updated.

The user interface of the Administrative Subsystem displays HTML-formatted output.

The Administrative Subsystem further provides Account Management functionality. The Account Management Interface gives authorized System Administrators full access to all available system and account management functions. The Client Account Management Interface will give each client access to a restricted subset of system and account management functions. Access permissions for account management function appear in the table below.

| | Help- | | | System | Client | Client |
|---|---|---|---|---|---|---|
| Entity/Data | desk | NOC | Accounting | Admin | Admin | User |
| Accounting | Read | Read | Read/ | Read/ | Read* | None |
| data | | | write | write | | |
| Client | Read | Read | Read | Read/ | Read* | None |
| Reports | | | | write | | |
| Client User | Read | Read | Read | Read/ | Read/ | None |
| data | | | | write | write* | |
| Client data | Read | Read | Read | Read/ | Read* | None |
| | | | | write | | |
| Subsystem | Read | Read | Read | Read/ | None* | None |
| information | | | | write | | |
| Admin | Read | Read | Read | Read | None* | None |
| Logging | | | | | | |

*The Client Administrator may only view and/or modify data to manage user accounts for that specific company. The Client Administrator is not permitted to view any information about any other company or the Ranger system. In addition, the Client Administrator may not change information about the client setup and configuration.

The Administrative Subsystem further preferably includes a Client Account Management Interface which allows a designated user employed by the client to administer user accounts for that client. Each client may have one user with administrator privileges or the capability of granting and revoking privileges to/from other users for that client. A user with administrator privileges will be able to create other users with administrator privileges and users with lesser privileges. Client Administrator privileges will apply only to the particular client account. That is, a client with Administrator privileges has those privileges only the Ranger activities for his/her organization. Only System Administrators will have Administrative privileges across all system files, accounts, and tasks.

Inputs to the Client Account Management Interface include user authentication data, all client tables from the database, all submission tables from the database, and a persistent data store of recipient information across all submissions.

The Client Account Management Interface may obtain its configuration information from the Configuration Database.

The Client Account Management Interface further preferably allows Client Administrators to perform user account management for that client's own users. Client Administrators have the ability to perform the following tasks:

Create Client User accounts

Set/Modify the following user permissions

submitting input for submissions

viewing reports

viewing billing information

viewing client global information

administering client account information

setting and modifying password

viewing a “trial” submission or message

Delete Client User accounts

Suspend Client User accounts

Display current levels of access for all users registered to the client.

Display a list of all users register to the client.

The Client Account Management Interface preferably writes out new or updated client user account information and permissions to the account data store. All access and actions via the Client Account Management interface are logged. In particular, actions that affect the operation of the system will have logging which includes date stamp, time stamp and the user information.

The Administrative interface also allows System Administrators to do user account management. In this respect, they have the ability to perform the following tasks:

Create User accounts

Set/Modify User Permissions

Set/Modify User password

Delete User accounts

Suspend User accounts

Display current levels of access for a user.

The Administrative Interface should provide System Administrators the ability to manage client accounts with the ability to do all the functions that a Client Administrator may do. System Administrators should have the ability to perform the following client management tasks:

The creation of a new client.

The creation of Client Administrator(s) for a client

Set/modify any necessary billing or customer specific attributes needed to process submission.

Submission priority linked to client billing

Set upload method (http, ftp)

List all clients

List all users for a given client.

Suspend a user account

Suspend a client (and thus all users) from using the Ranger system.

Assign and modify Permissions for user accounts

Delete or Purge a user account from the system

Delete or Purge a client account from the Ranger system.

Reporting Subsystem

A Reporting Subsystem is provided for generating reports on system status. Inputs to the Reporting Subsystem include, e.g., the Submission, Recipient and Tracking tables, Authorization and User data, Watchdog information, and Log files.

The information should be collected from each of the sub-systems and/or the various databases being used in order to report their administrative status.

The Administrative Interface should provide General Reporting that includes a summary of submissions that are in the system, who the client corresponding to the submission is, and the state of message assembly, message delivery, and errors. Selecting a given submission will bring up the detailed information on that specific submission.

A) General View

# submission submitted

# chunks a submission has been broken into

# recipients in a submission

# recipients per each DA type.

# messages sent, % complete

# Messages sent per DA type

# messages rejected

# messages read

A list of all the individual submissions in a table with the above information on a per submission bases. Also, will include: submission date and time scheduled assembly date and time.

An indication if assembly has started and % complete.

B) Detailed Submission View

job id, which is customer-specified.

submission id

submission date and time

submission submitter

# chunks a submission has been broken into

scheduled assembly time

assembly start or not

scheduled message delivery date and time

message delivery started or not

# recipients in a submission

# recipients per each DA type.

# messages sent, % complete

# Messages sent per DA type, % complete

# messages rejected, % of each DA type reject, % of all messages rejected.

# messages read

External Client Reporting Tool

An External Client Reporting Tool provides clients a means to monitor status of their past or current submissions, and to view statistical information on their usage and activities on the Ranger system. An External Client Reporting Tool is also provided and receives relevant data (inputs) from the relevant subsystems and databases, and displays them in Web browsers either in the form of tables (text) or visual graphics (such as pie chart, bar chart or curve).

The External Client Reporting Tool should only be accessible using standard web browsers and the Secure Socket Layer (SSL) protocol, including IE4.0 and NS4.0 or later.

The External Client Reporting Tool's users can view any reports concerning the usage and activities of the system performed by their own company/organization.

Only authenticated users should be able to access to the External Client Reporting tool. Users can should only be able to view their own data in the External Client Reporting Tool. Their own data (submissions, messages, etc) are securely protected on the server so that it can only be viewed by themselves.

The External Client Reporting Tool displays the Summary Information on the submission's status and statistic before displaying detailed status or statistic reports.

Stat Reports can be delivered to clients either on-demand on the Web, or in e-mail or by US Postal Service. Users can request e-mail report delivery either in text-only format or text-graphics format. Users can set up their preferred delivery schedule either daily, weekly, monthly or for every single submission. Users can change their US postal address or e-mail address for report delivery. Users can opt to export data in either raw, XML, or tab-delimited formats. The External Client Reporting Tool should be extensible to facilitate any desired changes to report type, format and content.

In the Summary Report, the status summary information should include the following information:

Submission ID

Submission's Senders

Submission Subject

Submission Status

Target Delivery (date & time)

% of Completed Submission

% of Pending Submission

In the Summary Report, the statistic summary information should include the following information:

Submission ID

Submission Subject

Total No of Recipients

Total No of Successful Deliveries

Total No of Failed Deliveries

Total No of Pending Deliveries

Average Time Delivery

The data displayed in the Status Report and Statistic Report screens are extracted from the subsystems/databases.

The External Client Reporting Tool can query the system database directly. Based on the current data model used for the system, the External Client Reporting Tool will query the Ranger database and perform joins/views on the following tables:

Submission

Sbm_track

Mesg_track

Rcp_track

Delivery

Message

In the presentation panel in the Status Report screen, clicking on the header of a column will result in the display of a sorted view of the Status table (sorted) by the clicked column values (either the ascending/descending order).

In the filtering panel in the Status Report screen, the following filtering criteria are presented for filtering:

Submit date

Submit time

Status id

DA types

In the filtering panel in the Statistic Report screen, the following filtering criteria are presented for filtering:

Submit date

Submit time

The External Client Reporting Tool should support two different types of detailed reports:

Detailed Status reports (can be referred as Status Report for short)

Detailed Statistic Reports (can be referred as Statistic Report for short)

In each of both the Status Report and Statistic Report screens, there are two panels: filtering panel and presentation panel. In the presentation panel in the Status Report screen, the data should be updated for a specified interval; that interval must be available for configuration. In the presentation panel in the Statistic Report screen, the data should be updated for a specified interval; that interval must be available for configuration.

There is only one view in the presentation panel in the Status Report screen that provides the status info on the submissions which are still in process or have already been completed but less than 3 days old.

A “Submit Filters” button may be provided in the filtering panel in both the Status Report and Statistic Report screens, which will update the presentation panel upon clicking or pressing event.

In the presentation panel in the Status Report screen, there are three different status reports presented for viewing in the tabular format which can be scrolled both horizontally and vertically:

Active submission status

Completed submission status

Scheduled submission status

An active submission status report includes the following information:

Submission Id

Submission's sender

Submit Time

Submit Date

Submission Subject

Total number of Recipients

Total number of successful deliveries

Total number of rollover deliveries

Total number of failed deliveries

Total number of pending deliveries

A completed submission status report includes the following information:

Submission Id

Submission 's sender

Submit Time

Submit Date

Submission Subject

Total number of Recipients

Total number of attempted deliveries

Total number of successful deliveries

Total number of rollover deliveries

Total number of failed deliveries

Total number of bounced deliveries

Total number of deferred deliveries

Total number of deliveries that remained unbuilt because of inability to reach recipient

Total number of deliveries to be resent

Total number of expired deliveries

A scheduled submission status report includes the following information:

Submission Id

Submission's sender

Submit Time

Submit Date

Submission Subject

Total number of Recipients

Target Delivery (time)

Expired Time

Estimated Time Delivery

Estimated Billing costs

In the presentation panel in the Statistic Report screen, different statistical views are supported (the 1st 4 views must be supported in the first version of the system):

Percentage of completed submission versus time delivery (Time statistical view)

Percentage of completed submission versus AVERAGE time delivery (Average time statistical view)

Percentage of successful, bounced, rejected and deferred deliveries (Delivery statistical view)

Percentage of recipient who have read the message versus submission (Recipient statistical view)

Percentage of different message formats (ASCII, HTML, XML, WML, SMS, etc.) (Message statistical view)

Percentage of number of messages versus DA Type (DA statistical view)

Number of bandwidth utilized versus submission (Bandwidth statistical view)

Number of KB graphics, KB text and average message size (in KB) (HTML statistical view)

Number of click-thru clicks, ad-banner clicks versus submission Id (Click statistical view)

Percentage of SLA (Service Level Agreement) compliance versus submission (SLA statistical view)

In the presentation panel in the Statistic Report screen, the following choices are presented for selecting one or more views to be displayed:

Time statistical view

Average time statistical view

Delivery statistical view

Recipient statistical view

Message statistical view

Delivery Agent statistical view

Bandwidth statistical view

HTML statistical view

Click statistical view

SLA statistical view

In each statistical view in the Statistic Report screen, data can be visually displayed in the form of a bar chart, pie chart or curve, or can be displayed as text in the tabular format.

System & Network Monitoring

Initially, each system should be monitored by a Network Operations Center (NOC) using, e.g., HP OpenView. Thresholds should be decided upon, and procedures developed to respond to conditions exceeding thresholds. This includes, is not limited to, the following on each machine:

System load

Memory

Swap use

Disk utilization

Disk performance

Network Utilization

System & Network Monitoring functions will give operators, system administrators, and service administrators a view of the overall health of the system through a web Browser. Features available may include, e.g., the following:

Watch dog process with alarms.

Real time view of System going down or not responding available on refresh period, set as a configuration DB element.

Accessible information should include, but not be limited to, the following:

A list of all major sub-systems, the machine(s) that they are running on, and their state (up, down, degraded, administratively down), and the current load on those subsystems should be viewable.

The EDA Statistics Cache information should be viewable sorted based on domain name or it's rank in receiving messages.

Watchdog Subsystem

A Watchdog Subsystem is preferably provided and has responsibility for monitoring all the subsystems and reporting on their application level health and status. It is not intended to replace network or host monitoring software, such as HPOV or BMC patrol.

The Watchdog Subsystem monitors the following conditions:

Number of available threads per subsystem instance

Availability of each individual subsystem

Subsystem utilization level (memory, queues, disk, . . . )

% Complete of current jobs.

The Watchdog Subsystem will obtain its configuration information from the Configuration Database.

In-Memory

Instant Messenger Cache

The Instant Messenger Cache stores account information (login and password) for IM servers. Multiple login accounts will be required per ImType to allow multiple IMDAs to deliver to a single ImType simultaneously (only one login at a time per account). This database will store whether or not a login and password combination are currently in use.

The Instant Messenger Cache will accept IM server login information input from the Administration module:

ImType

ImAccountID—Ranger assigned ID that identifies this account information

ImLogin—Screenname

ImPassword—Password for ImLogin

InUse—True/False, tells whether or not this account is in use

The Instant Messenger Cache inserts data received from the Administration module into the database. It also responds to requests for account information from an IM delivery agent. When an account is made available to a delivery agent InUse is updated to reflect that the account is in use.

The Instant Messenger Cache preferably provides the following IM account information.

ImLogin

ImPassword

The Instant Messenger Cache also provides account listings and account status to the Administration module:

ImType

ImLogin

ImPassword

InUse

MTA DMTA Database Cache

The developer interface to the DA stats cache is a query utilizing a domain name with an IP address returned. The IP address returned will be determined in an efficient, load-balanced method from a set of IP addresses.

Domain lookup code must be accessible quickly via an efficient hash. Additionally, if a domain is not found via the hash algorithm, that must indicate that the domain is not in the hash, not that that the hash algorithm missed.

The domain cache algorithm should reload data on a configurable interval or when a SIGHUP is received by the parent process, i.e., Select IP, ConnectTo, HelloTo from DAStats, MX where DAStats.DomainID=MXDomainID and MxHelloTo<=(DAStatsHelloAvg+N*DAStatsHelloSdev) and MXStatus=‘up’ and MXPrefernce=(select min(preference) from MX MX2 where MX2DomainID=MxDomainID and MX2Status=‘up’) group by DAStatsDomainID.

The domain cache must govern it's own timing to meet the above requirement without requiring programmer intervention.

System External Interface

A single web location is provided to which all system clients will connect for access to all client functions. The external interfaces supported by the system preferably include:

Online user access web pages for registered customers

Online user access web pages for administrative users

External interfaces are provided for electronic mail and Instant Messenger.

Systems and Network Architecture

VRM/Load Balancing

Appropriate VRM/Load Balancing solutions are available from Cisco, Resonate, Radware and IPivot. Certain key discriminators may be used to determine the product(s) appropriate for the System. Those criteria include:

Architecture

Performance and Scale

Reliability

Feedback Techniques

Redirection Methods

Policies

Advanced Features.

Each of these are described, together with the specific attributes appropriate for the System, in the following paragraphs.

Architecture

Distributed architectures are a must, so that the Load Balancing units do not themselves become either a bottleneck or failure point. Packaging, platform and form-factor all are considerations as well. Software-only solutions, Packaged, PC-based offerings and Custom Hardware are all available. Although some very large companies are involved in this market space, none of them (with the exception of possibly Cisco) have the best products.

The packaged solutions offer the advantage of minimal configuration effort while maintaining reasonably up-to-date feature sets, since custom hardware is not involved. Radware, Ipivot and Cisco all offer solutions of this type. Capacity upgrades per unit are not as straightforward as with the software-only solutions. Custom ASIC-based Switching VRMs help to simplify overall configurations by combining load-balancing with a layer 2 or 3 switch, but tend to lag in features, behind the other types. Performance is mixed in this category as well, ranging from not great to arguably the very best performer of any type (from Alteon Systems).

Performance and Scale:

| | | |
|---|---|---|
| Hits per second | 36 | 720 |
| Number of simultaneous users | 50,000 now | 1M in 4 yrs |
| Bandwidth | 7.6 MB/sec | 140 MB/sec |

Preferred Feedback Techniques

Active Content Verification (ACV) with response time monitoring should be available.

Redirection Methods

DNS Re-Direction is preferred as basic, or core.

Recommended Policies

Weighted Round Robin or Least “Used” (connections or CPU or RAM). QoS policies concerning moving resources between applications during peak loads are also nice to have. Any Geographically-dispersed load-balancing policy should be based on the Acuitive advice to “use a site in your region unless it's on fire.”

System Interfaces

External Interfaces

In order to support both current & new customer data requirements in a robust fashion, external interfaces are based on XML wherever possible. This includes bulk data input, as well as DA-specific data transformations (formatting in HTML, WML, IM formats, etc.). The System may output HTML to browsers, and may also utilize data-bound XML for clients that can handle such.

The following subsystems will support DA-specific protocols:

| | |
|---|---|
| EMail DA | QMTP & SMTP |
| IM DAICQ & OSCAR | |
| OOBs | SMTP |
| Pager DAs | QMTP & SMTP |
| PDA DAs | QMTP & SMTP |

Internal Interfaces

Internal system interfaces are based on the RMI, ‘X’ & QMQP protocols. The system may be designed to utilize RMI-IIOP should the need arise to integrate with CORBA applications (such as client ‘back-end’ systems). The following essential application services communicate over RMI:

Data Input

Validation & Load

Submission Routing

Delivery Scheduling

Assembly Engines

WAGs

Tracking

The following subsystems should support XML:

Data Input

Assembly Engine

WAG

The Data Input subsystem uses RMI for internal communications, but also supports XML—centric document exchanges with clients. The Assembly engines need to understand XML & perform XSLT transforms, but communicate internally over RMI & QMQP+ (to DAs).

The following subsystems need database access either through container—managed persistence, a database connection (JDBC) and transaction management service or directly:

Validation & Load

Submission Routing

Delivery Scheduling

Assembly Engines

WAGs

Tracking

Bean-managed persistence is also necessary for complex queries & update transactions flowing through EJBs.

Process Distribution

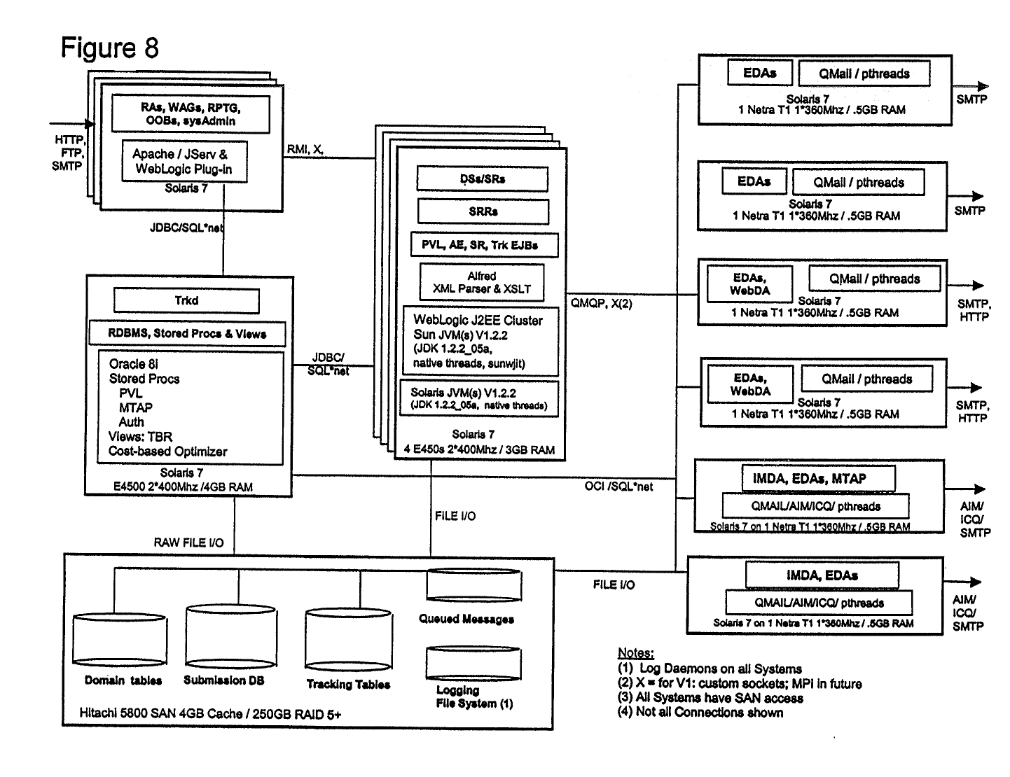

The diagram given in FIG. 8 portrays a mapping of logical processes and application layer protocols to the physical nodes comprising the System. Note that not all DB links are shown, due to diagrammatic limitations. The flow of information proceeds (roughly) from upper-left of the diagram through the lower left, then on through the center & out on the right.

Both the Delivery Schedulers and Submission Router subsystems are shown running non clustered, on a pair of Sun ‘workgroup’ servers: a dual-CPU E450 and a single-CPU E250. This node specialization will enable significant throughput gains and may be augmented through judicious use of stored procedures, so that data access, parsing & formatting computations can be shared across a larger number of processors, I/O channels and controllers. Both the assembly engine and the parsing, validating Loaders (‘pvLoaders’) will run as EJBs hosted under the J2EE compliant WebLogic Application Server (WLS).

WebLogic plug-ins on all web servers enables them to communicate efficiently over RMI to any components & EJBs in the application tier. Data input is run on a triplet of Netra T1s, together with the WAGs and reporting & billing subsystems, all of which is implemented with Servlet technology, utilizing the Sun MVC guidelines, time permitting. All three run Apache with the WebLogic plug-in &/or Jserv. ‘Front’ or ‘Controller’ servlets will run under Solaris JVMs on these machines. In addition, the Input subsystem also incorporate a customized set of integrated ftp daemons.

All Delivery Agents run on TTs, as well, for maximum control of scale-group increments. Initially, 4 or 5 are allocated to the Email DAs (including EMail-gatewayed pager & PDA DAs), with two for IMs and Probes. The Email & IM DA scale groups will therefore provide some measure of redundancy as well as scaling potential.

Naming & Directory Services

Service Location

JNDI & SQL

Service lookup (& the foundation for Location transparency) is supported through a distributed service naming mechanism. For Java components with access to the WebLogic Server (WLS) cluster, this may be accomplished through use of the WLS implementation of the Java Naming & Directory Interface (JNDI). This should provide location—independent service look-up for all Java services. The WLS JNDI supports multiple types of service directories, including LDAP, SQL, NDS, etc. For V1 Ranger, an SQL table (or set of tables) is used to support this capability. The following information should be stored in this service ‘directory’ regardless of implementation:

service lookup data structures:

services:

service_name

service_hostname (or ip_address)

service_port_no

service instances:

instance_name

instance_hostname (or ip_address)

instance_port_no

preference/priority

service_name (FK)

Searching the first table by service name would yield a unique (load balanced) host+port combination for client subsystems to connect to. A search by service name on the join of these two tables should yield all rows for the named service to see which instances are mapped to which services. Searches by instance name on the second table should yield a unique row (a single host & port# combination). The first will be useful for client subsystems seeking connections to a service, while the last would support subsystem queries for host&port combinations to which listeners must be bound.

The same table(s) may be used to support service lookup (as well as other critical service management capabilities, such as configuration lookup) in a common fashion for both Java and C/C++ subsystems, in the following manner:

SQL-basis

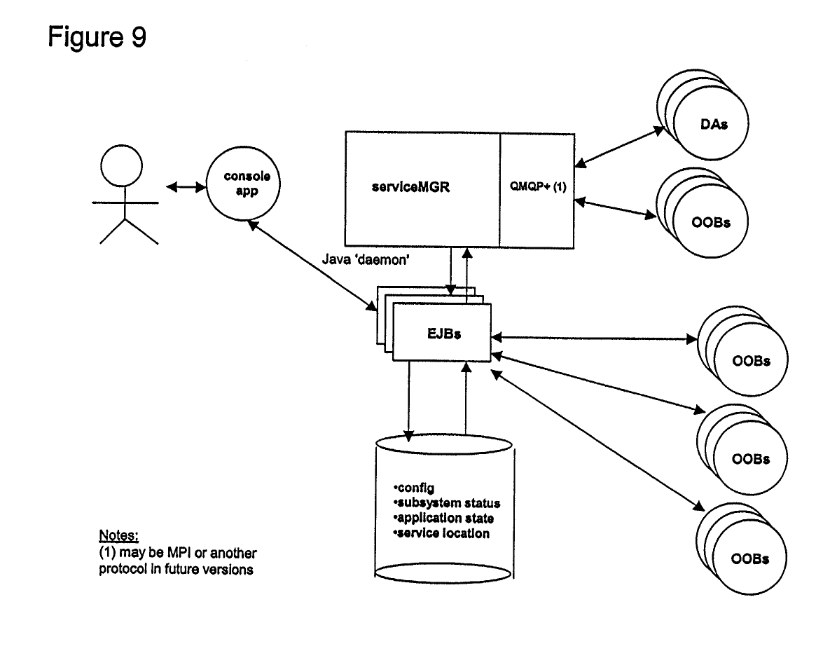

Those subsystems which do not have access to the SQL database, nor to JNDI (i.e., possibly the DAs), service lookup may be supported from the same data structures, but via another subsystem, the Configuration & Service Manager (CSM). This subsystem is comprised of a set of persistent Java process(s) and a set of entity beans backed by the Oracle DB. All ‘client’ Java subsystems invoke methods on the remote interface of these beans to get config information, update subsystem status, and, if necessary, lookup service host & port combinations (although this last should be performed via WLS JNDI). The concept is illustrated in FIG. 9.

C processes will need either client libraries to connect to the CSM or direct knowledge of, and access to, message formats for requesting and receiving configuration, status & service location information. They then forward the messages & requests on to the CSM daemon(s) and through the CSM EJBs to the DB. The inclusion of a library with the necessary methods/functions needed for the CSM API would enable those subsystems with neither JNDI nor DB access to still acquire service location (host address & port#) information in a centralized, standard fashion.

Such an API should include functions of the following type:

char * getmyHostandPort(char * myServiceInstanceName);

char * getRemoteServiceHostandPort(char * remoteServiceName),

To make this work, one additional piece is required, namely, a ‘bootstrap’ service-lookup for the CSM. This may be provided via the same config DB table via the same EJBs, or as an alternative, by configuration flat-files mounted on the NFS (Netapp) filesystem. The daemons, of course need DB connection information, but this is commonly provided through the Oracle client connectivity infrastructure (the tns_names.ora file).

Note that standard configuration information available in the config DB table, together with system/subsystem status information (in the system_status DB table) could also be made available in the same fashion.

A (system administration) client page is needed to allow sysAdmins to

perform queries as well as update DB settings via the CSM beans.

Alternative: NFS Flat-files

A viable alternative to the SQL basis just described is to use flat files mounted on the NetApp (NFS) filesystem for all configuration information, including service lookups. Since all nodes in the Ranger complex will have access to the NFS filesystem, all services could read the required host+port combinations from these flat file(s). Regardless of implementation, however, the information to be carried in the service-lookup data structures is essentially the same.

If flat-files are used, it may still be useful to generate them from a central pair of DB tables, then utilize a simple query process to export this information and store in the NFS filesystem.

Interface Support

There are 4 major categories of interfaces that should be considered for the System, all of which may be supported using a combination of the Sun J2EE specification, supplemented with the XML standard.

These 4 categories include:

1. Client Data input—for V1, a set of XML DTDs will be specified with sufficient flexibility to allow for client-specific data substitution & DA-specific formatting. Future versions may support ICE, or some form of XML-RPCs (WIDLs)

2. Inter-process communications—the JNDI & ‘CSM’ approach just described should be used for service location, configuration, status reporting & naming. RMI (the WebLogic optimized version wherever available) for remote invocations will allow Ranger Java components to communicate effectively. QMQP+ and/or an Ranger sockets-layer API (‘X’) for remoting IPCs among C processes or between C & Java processes. Future versions may upgrade to the Tuxedo ‘message switch’ technology.

3. Database Access—direct DB access will be limited to a minimal set of common DB—oriented services (e.g., tracking, AEs & DSs). These services will pool connections & provide an abstract DB interface using WLS optimized JDBC or native DB interfaces (where necessary for performance, e.g. pro*C/OCI over SQL*net)

4. DA-specific protocols—to support remote interactions with message facilities such as MTAs, IM servers, etc., the native protocols will need to be supported. Such support will be provided with an abstraction layer within each DA. to shield the rest of the Ranger application to the extent possible from changes in these protocols. Supported protocols will include: QMTP, SMTP, ICQ, and others.

Database & Transaction Services

Processing Model

Although direct client subsystem access to the System's database is minimized, the transaction processing model will resemble very closely that of a very high volume OLTP application. The clients responsible for much of the transaction volume on a constant basis will be certain of the services within the System itself, especially the following modules:

Parse, Validate & Load

Delivery Schedulers

Assembly Engines

Tracking Daemon(s)

WAGs

Other components may also require direct DB access, most other services will perform the bulk of their updates/inserts through the tracking subsystem daemons. With projected volumes numbered in the 10s of K tps, a very aggressive and super-fast DB model is required. The relational model is chosen for this application as a natural fit, as well as being the state-of-the-art for all but the very most complex of entity types and relationships.

RDBMS vendor

The most robust and fastest RDBMS in the server tier is Oracle. This DB engine has been chosen as offering the very best combination of world-class speed, robustness & reliability, as well as entity & relational integrity. Special features and tools available with 8i made this particular version the most attractive. The foundation for all database storage for the System is preferably a set of tables implemented in Oracle 8i.

Transaction Processing

DB connection pooling and ‘funneling’ or multiplexing will be supported via the Tuxedo or M3 tpm/OTM products from BEA systems (in future versions). The connection pooling bundled with Oracle 8i and/or the container—managed persistence and optimized JDBC classes available with the J2EE-compliant server (WebLogic) may be used.

Caching

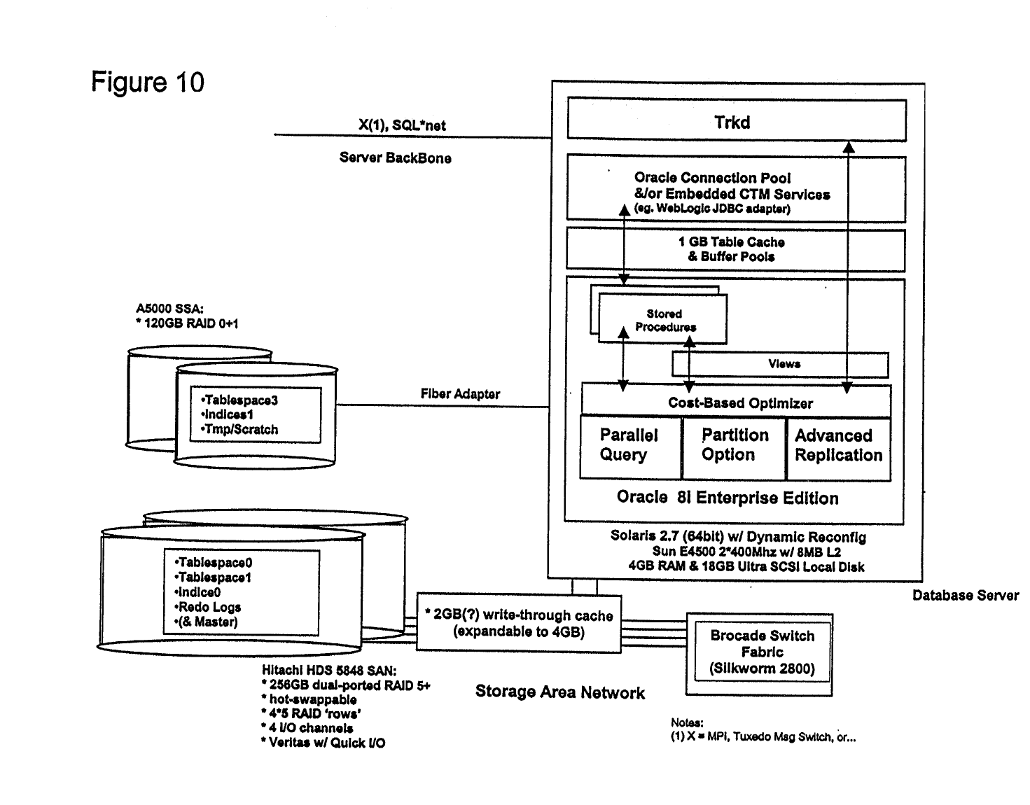

The fastest performance can be achieved when DB operations are performed at (or usually at) memory, rather than disk speeds. For this reason, two levels of caching are preferably used. The first is provided by the local RAM on the E4500 DB server, as shown in FIG. 10.

As much RAM as may possibly be spared on this machine should be configured for Table (and index) caching. An estimate of just over half of the total RAM can be made available for this purpose. The second level of caching will provide ‘disk write spoofing’ with nearly 100% guarantee of RAID disk write commit at the file-system level, so that even the RDBMS will ‘see’ the second cache as disk.

Of all the database elements which may benefit from this two-layer caching, the following are top candidates:

redo logs for active submission DBs

tracking tables (recipient track, msg_track & sub_trk) for active submissions

primary index files for these tables

This caching concept may be extended further using super-high performance memory-optimized databases or DB-‘front-ends’ from vendors such as TimesTen to achieve transaction rates of the stated magnitude.

Database Organization

The primary DB organization schemes available for satisfying the needs of concurrent submissions for multiple clients include the following:

One DB w/one set of tables for all submissions

One DB with separate table spaces containing table-groups per submission

Multiple DBs (one per submission)

The drawbacks to #1 include both ‘perceived’ security risks for individual clients and other ‘trust’ issues as well as super-large table cardinalities (in the hundreds of millions or even billions of rows possible). The advantage is simplicity and consolidated overhead.

Approach #3 brings up serious resource—waste and overhead issues, with up to twenty-four DBs per day being created (or loaded) and possibly hundreds concurrently maintained (if submission lifetimes are measured in weeks.)

The best approach maybe #2, whereby all ‘common’ or ‘persistent’ tables are accessible to groups of tables ‘owned’ by individual submissions, the naming & access conventions for this approach would involve:

ownerID.DBname.tablename.columnName

Web Services

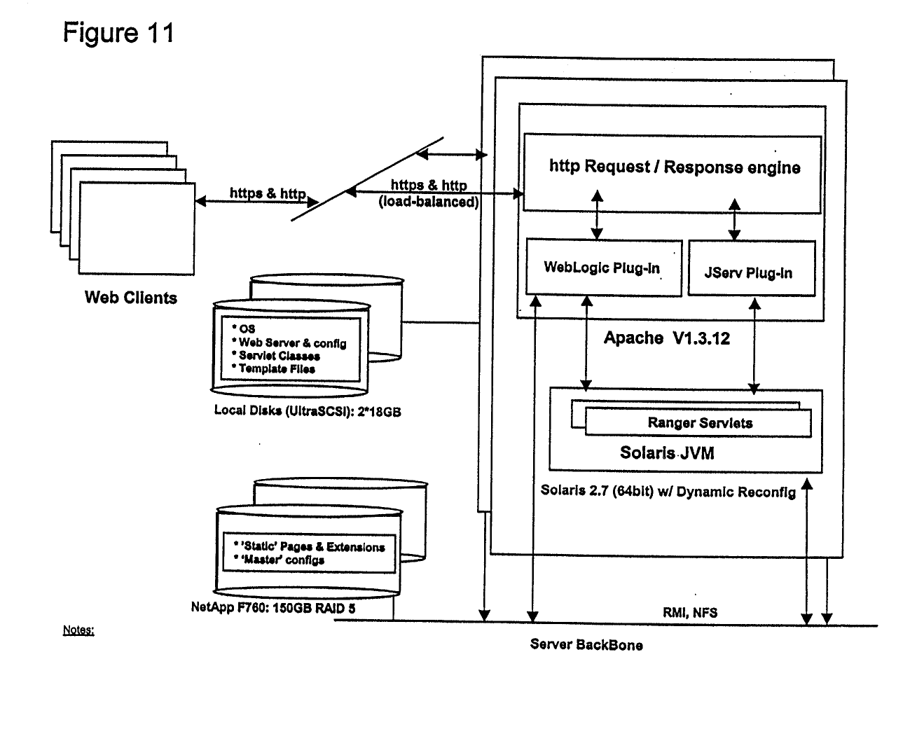

As shown in FIG. 11, Apache is preferably used as the standard web server for all web components, including:

the Web Agents (WAGs),

the Data Input subsystem,

the System Administration pages

Client Reporting.

As far as possible, Weblogic is used to manage all Servlets employed for dynamic page creation (JSP is deprecated for this project). Hence the Weblogic plug-in for each Apache instance, as shown in the figure.

Where a budget-driven fall-back is required for Servlet management, Jserv (also from Apache, and strongly influenced by Sun's J2EE initiative) may be utilized. If necessary, a hybrid architecture incorporating both can be fielded, although the preference would be for a pure Apache—Weblogic implementation, for simplicity of configuration and maintenance. All Web nodes run on Netra Tis with 0.5 GB of RAM and 36 GB local disk. The OS, Web Server SW, config files, Web server logs and ‘static’ pages, are stored locally along with the ‘Front’/‘Controller’ Servlet classes.

Servlets run under the JServ Engine using Solaris JVM(s). The interfaces from the ‘Front’ or ‘Controller’ (main navigational, ‘gateway’) Servlet to other classes utilize standard object instantiation and method invocation. EJBs are employed using standard J2EE interfaces, as supported by the WebLogic plug-in. Thus, the application designers need only invoke methods on the ‘remote’ interface to each bean and not be concerned about the details of bean location or management. Typical bean life-cycles will involve one call to instantiate a ‘bean-home’ followed by a bean-home.create( ) invocation. This form of remote method invocation (RMI) is supported over the highly-optimized Weblogic RMI via the WebLogic plug-in.

Application Services

EJB Components

Key application-layer services run under control of the Weblogic application server, thus deriving full J2EE-compliant life-cycle management and component support, including optimized, multiplexed database connection caching and pooling, transaction management, persistence, state maintenance, process monitoring and restart, thread management and flexible security.

The following services run in the JVMs managed by WebLogic:

Assembly Engines

Deliver Schedulers EJBs

Submission Routers EJBs

Parsing/Validating Loaders

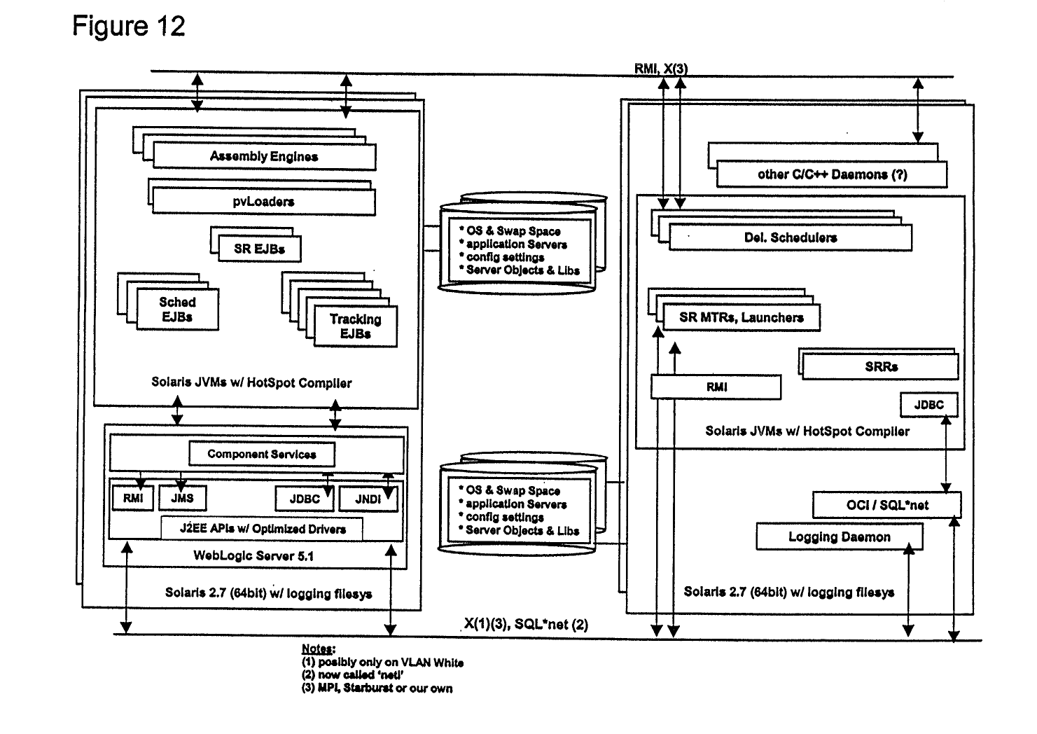

These services are constructed of distributed components conforming to the EJB specification. Key APIs to be employed will include RMI, JNDI and JDBC, as shown in FIG. 12. All of these are J2EE conformant interfaces presented by highly optimized and configurable WebLogic services. At least two of the E450s will need to run instances of WebLogic with the clustering option.

Although this diagram portrays both the WLS & the Tuxedo message switch running on each of the four ‘middle tier’ server nodes, this is not required, nor necessarily optimal. The ‘Jolt’ interface shown is a remoting IPC connection for exchanging high speed messages, so that instances of the WLS and Tuxedo message switch may be allocated as desired across machines in this tier. A minimum of two instances of each is recommended for redundancy.

Messaging Services: Delivery Agents (DAs)

For the Delivery Agents, a set of high-performance messaging servers are utilized, all based upon a similar architecture comprised of the following elements:

C language implementation

static libraries for common services

support for QMQP+ for intra-system messaging & queuing

support for:

either: QMTP & SMTP for communication with remote

or: ICQ & OSCAR for communication with MTAs & IM Servers

a disk-based retry queue for temporarily holding outbound QMQP messages

multi-threaded design

Init, reconfig & thread management components

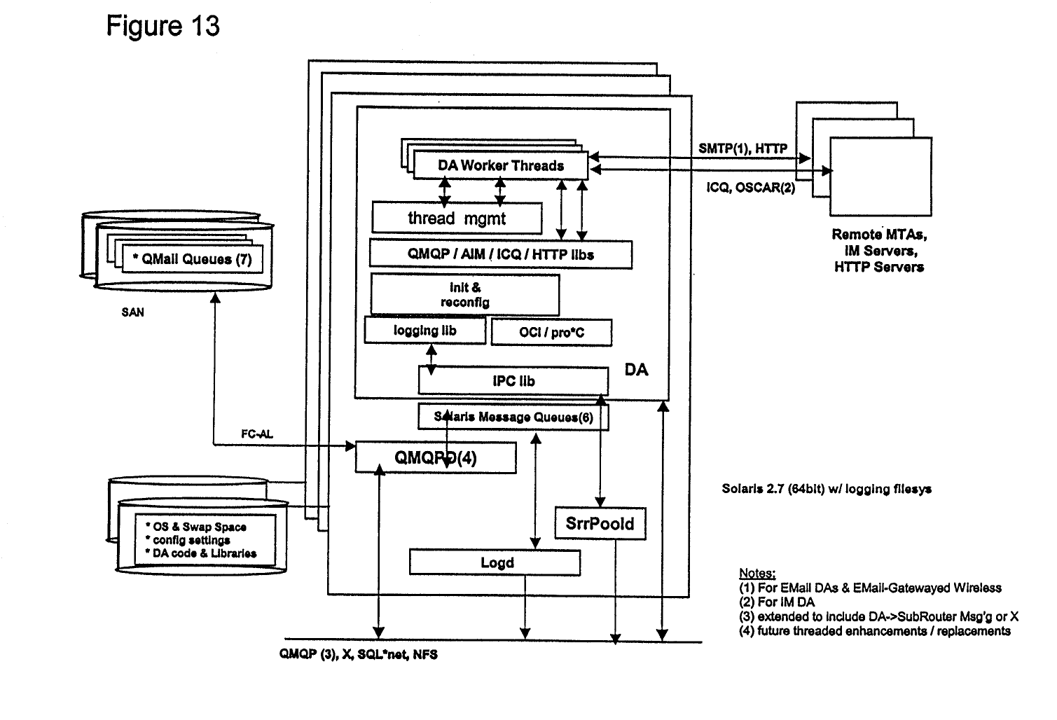

This architecture is shown in FIG. 13.

C/C++ Services

The Tracking Subsystem, together with the Assembly Engines and DAs may utilize the Tuxedo message switch technology and therefore incorporate services built to the Tuxedo ATMI API. This provides a super-fast, bi-directional, multiplexed, rich socket interface. This IPC requirement will need to be met by a sockets-layer API. The retry queue will be necessary for handling QMQP messages which soft-fail on the first delivery attempt. This queue is serviced by a disk-based ‘vanilla’ version of the Qmail EDA.

As shown, a threaded version of the QMQP daemon is combined with a threaded version of the delivery agent itself (formerly Qmail send, rspawn & remote). The worker threads which handle remote MTA interactions are dispatched from a pre-allocated pool upon receipt of a new message by the QMQPD listener(s). These listener(s) will support a persistent variant of QMQP called QMQP+ for accepting message flows from the AEs.

Oracle access by the DAs may be necessary. If so, it may be used for configuration & service location lookups, etc. Normal tracking flows, however, should go through the responses to the AEs and through the SRs.

Inter-system protocols such as QMTP & SMTP will need to be supported for EMail DAs & ‘EMail-Gatewayed’ Wireless DAs. The latter may differ very slightly from the EMail DAs, or be part of a common implementation. For IM DAs, the roughly corresponding protocols will be ICQ & OSCAR.

The decision to model IM DAs after the EMail DA design is made to try to simplify overall interface complexity for the application, and in particular, the Assembly Engines. If all DAs can support just one disk-based and one ‘remoting IPC’ protocol for intra-system messaging, then the Assembly engine's burden of complexity is kept to a minimum.

‘Worker Thread’ pools should be created at startup so that individual threads may be detached and assigned to message processing (de-queuing & transmission) as quickly as possible. Signal-handling, (re)-configuration and initialization tasks should be provided for. As far as possible, separate components should be encapsulated in discreet functions in order to isolate them from each other and the main logic flow. Clear and distinct interfaces for each service, API and protocol should be elaborated at design time.

The QMQP+ protocol may be replaced by a Tuxedo message switch client or other protocol ‘X’ candidates. The client may be implemented if desired to enhance intra-system messaging performance. Such a client would be configured to carry Intra-system Logging & Tracking messages as shown and possibly QMQP traffic as well.

User Interface

A permutation of the Sun Microsystems’ Model-View-Controller (MVC) architecture should be employed as far as possible for all user-facing web pages, with the possible exception of the WAGs. JSP is deprecated, however, in favor of a set of Servlet classes designed to handle HTML page generation, embodying methods for header, trailer and body.navigation and body.content generation.

Controller Servlets may be used to extend the httpServlet class, while model classes may be implemented as EJBs or at least employ beans, as appropriate, for DB access.

Basic I/O Operations

Directory Organization

In order to keep the size of directories below operational limits, messages will be written to separate directories within directory trees of minimal depth. A variety of methods for dividing a set of messages are possible, including by message group or ‘chunk’. For deferred deliveries in particular, some form of message allocation among sub-directories within a chunk may be necessary. The following guidelines are suggested:

A directory tree whose ‘root’ name will contain the client identifier

One ‘parent’ subdirectory within the root for each chunk of the delivery

N subdirectories within both each chunk directory, created dynamically

never more than K files in any directory where K is configurable at initialization time (and probably never more than a few hundred)

as far as possible, create chunks across distinct file systems

Distinct file systems are recommended in any case to maximize file I/O performance, even where a SAN or NFS appliance is used. Up to a point at least, the more spindles involved in a write operation, the better.

Use of MAILDIR Protocol

The maildir protocol may be used for file storage where multiple writers and readers need to operate on a common set of files. File locking is normally required to ensure that file-reading clients will never try to open or use incomplete files. The maildir protocol circumvents the need for file locks by declaring that all writes are performed to a directory (usually\tmp) separate from that used for reading, with a move operation from tmp to the queuing directory after each write. Depending upon the relative performance achieved by this approach, the maildir protocol will likely be used instead.

Use of SAN Filesystems and NFS-safe Mounted Partitions

SAN storage may be utilized for message queues of all types. The NFS appliance can supply filesystems for logging files, configuration files and other common files. Local disks should only be used for storage of copies of:

packages

SW products

config files.

QMQP

For disk-based message queuing, the Quick Mail Queuing Protocol (QMQP) may be used. QMQP provides the following advantages:

centralized mail queue within a cluster of hosts

much faster than SMTP (Simple Mail Transfer Protocol).

QMQP clients & servers are easier to implement than SMTP servers/clients.

QMQP employs the NETSTRING encoding of data and uses TCP/628 transport.

Netstrings

A netstring is a self-delimiting encoding of a string which eliminates the need for end-of-string zero-byte searching. It has the following major characteristics:

Declares the string size up front.

Basic building block for reliable network protocols.

Any string of 8-bit bytes may be encoded as [len]“:”[string]“,”.

Example:

String: “hello world!”

Encoded as: <31 32 3a 68 65 6c 6c 6f 20 77 6f 72 6c 64 21 2c>,

Alternate: “12:hello world!,”.

File I/O

Block buffered file operations are preferred where possible for basic file input and output (I/O). This implies the use of, for C programs:

int read(int fd, char *buf, int n);

where the arguments are as normally specified, but ensuring that the 3^{rd} argument is tuned to a multiple of the blocksize in use on the filesystem in question. This may be set to 1024 bytes. The corresponding output function is, of course, write.

For java programs, buffered I/O is possible using the BufferedInputStream and BufferedOutputStream classes, where writes, for example, would be invoked on a BufferedOutputStream instance buffO, such as:

buffO,write(byte[ ] my Buff, int offset, int len);

Remoting IPCS: Application—Layer Messaging

As set forth above, remote interprocess communications (remote IPC) requirements of the system may be met by a combination of:

RMI for Servlet—EJB, Bean—Bean and Java ‘daemon’—EJB invocations.

RMI-IIOP or ‘X’ for Java—C communications.

QMQP+ for Assembly Engine—DA message streams.

Alternative candidates, for protocol ‘X’, include the WebLogic/Tuxedo message switch, and the Message Passing Interface (MPI), Starburst, and IP multicast protocols.

A sockets-layer interface API may be used by subsystems which require it. Persistent TCP sockets may be utilized wherever possible. That is, connections between subsystems (or between tracking client library instances & tracking daemon(s)) will be established at start-up time (as well as upon receipt of SIG_HUP).

Although a large number of functions are available in robust messaging libraries such as Tuxedo, the Sun MPI implementation, or IBM's MQ Series, for example, and a wide range of distributed application problems may be solved with about 6-8 major functions. These functions are usually of the following types:

communications (library & related facilities) initialization

communications (library & related facilities) termination & release

interface characteristics detection

interface characteristics selection

connection establishment

connection shutdown

send

receive

For MPI, for example, some sample functions in these categories are:

MPI_init

MPI_Finalize

MPI_Get_version

MPI_COMM_size & MPI_Comm_rank

MPI_Comm_connect

MPI_Comm_disconnect

MPI_Send & MPI_Bsend

MPI_Recv

Using sockets, these types of functions are performed by the following calls:

getsockname

getsockopt

connect

shutdown

send

recv

For Tuxedo, the following calls are used to accomplish similar tasks:

tpinit

tpterm

tpbegin

tpcommit

tpcall & tpcalla

Although for Tuxedo, the tpbegin & tpcommit calls also include the notion of a transaction, so that multiple messages (to multiple partner components, if desired) may be incorporated into a single ‘unit of work’, with the usual ‘atomicity’ guarantees.

A common set of functions should be established, one for each of these categories of communications service, with the argument syntax sufficient to make later migration to either MPI or Tuxedo a little easier. A complete ‘metaAPI’ may not be necessary, nor worth the effort. But some consideration should be given now to defining a set of standard ‘system sockets lib’ functions (methods) rather than have each subsystem implementing things in varying ways.

These half-dozen (or dozen) routines can be built just twice, once for Java and once for C/C++, fairly quickly, then used as needed throughout the system. After all, it is not the functionality, but only a thin interface ‘wrapper’ function that will be required in each case.

For example, to take the MPI_Send function and map it to the socket send call:

MPI_Send(void *buf, int count, MPI_Datatype dtype, int dest, int tag, MPI_Comm comm);

size_t send(int s, const void *msg, size_t len, int flags);

would appear difficult. However, a simple function layer may defined between, such as:

size_t eFsend(int s, const void *msg, size_t len);

the use of which would make it possible to ease future migration efforts as well as simplify the interface for all subsystem authors. Note that certain of the arguments in the MPI call may be set internally by the interface layer and therefore not presented as ‘public’ arguments to the eFSend function. The MPI_Datatype dtype can be handled in this way: if all messages are transmitted as ‘flat’ sequences of chars, for example, this could be set to MPI_CHARACTER inside the eFSend function. The MPI_Comm comm ‘conmmunicator’ indicator as well may be set internally to MPI_COMM_WORLD (the MPI default). Similar handling should work for the MPI args int dest and int tag, leaving void *buf and int count which map to the socket send function's const void *msg and size_t len, etc.

This technique may require that the arguments not present in the eFsend wrapper call (the one to actually be used by client subsystems) will have to be handled (set and passed internally) within the eFsend function itself, possibly in cooperation with eFcomm library initialization. Finer grain-controls such as MPI_Datatype dtype may be needed at the individual subsystem level rather than being set internally by the eFsend function library routine on behalf of, and transparently for, each client subsystem. If such level of control is not needed, this approach should work.

This will allow rapid implementation of a very thin layer that ‘hides’ the details of sockets functionality from all ‘client’ subsystems, so that future changes in communications routines may be mostly confined to the set of eFcomm API routines. For further ‘protection’ an ‘escape’ argument such as struct eFComm comm could be defined as in:

size_t eFsend(int s, const void *msg, size_t len, struct eFComm comm);

which will allow passing (in future) any arbitrary (currently unforeseen) collections of arguments required by future APIs. Given the foregoing discussion, the following baseline eFcomm library functions are proposed:

For all functions, the structure ‘eFcomm’ is defined as:

struct eFCommStruct

{

char[2] version;

char *placeholder

};

For all functions, all arguments except for eFcomm and any others noted have the meanings defined for the sockets library.

A Java class or classes with corresponding functionality will be defined. It may be based, if possible, on the WebLogic ‘rich’ sockets interface.

eFcomm library functions:

| | corresponding | description |
|---|---|---|
| function name | sockets | lib function |
| 1. eFCommInitn/a | | - initialize the eFCommLib |
| 2. eFOpenConn: | socket (n) | - Open a TCP network connection |
| int | eFOpenConn | (int domain, int type, int protocol, |
| | | struct eFcomm ); |

| | |
|---|---|
| where: | |
| int domain | = PF_NET |
| int type | = SOCK_STREAM |
| int protocol | = |

| | | |
|---|---|---|
| 3. eFAccept | accept (3xn) | - accept a connection on a socket |

int eFAccept( int s, struct sockaddr *addr, socklen_t *addrlen, struct
eFcomm );

| | | |
|---|---|---|
| 4. eFBind | bind (3n) | - bind a name to a socket |

int eFBind(int s, const struct sockaddr *name, socklen_t*namelen, struct
eFcomm );

| | | |
|---|---|---|
| 5. eFConnect | connect (3n) | - initiate a connection on a socket |

int eFConnect(int s, const struct sockaddr *name, struct_t namelen, struct
eFcomm );

| | | |
|---|---|---|
| 6. eFGetConnOpt | getsockopt (3n) | - get options on sockets |

int eFGetConnOpt(int s, int level, int optname, void *optval,
socklen_t*optlen, struct eFcomm);

| | | |
|---|---|---|
| 7. eFSetConnOpt | setsockopt (3n) | - set options on sockets |

int eFSetConnOpt(int s, int level, int optname, const void*optval,
socklen_t optlen, struct eFcomm);

| | | |
|---|---|---|
| 8. eFListen | listen (3n) | - listen for connections on a socket |

int eFlisten( int s, int backlog, struct eFcomm );

| | | |
|---|---|---|
| 9. eFRecv | recv (3n) | - receive a message from a socket |

ssizet_eFrecv( int s, void *buf, size_t len, int flags, struct eFcomm );

| | | |
|---|---|---|
| 10. eFSend | send (3n) | - send a message from a socket |

ssize_t eFsend( int s, const void *msg, size_t len, int flags, struct
eFcomm );

| | | |
|---|---|---|
| 11. eFCloseConn | shutdown (3xn) | - shut down socket operations |

int eFCloseConn( int s, int how, struct eFcomm );

| | | |
|---|---|---|
| 12. eFCommTerm | n/a | - terminate & release comm lib |

Operational Concepts
DECREASE MEMORY REQUIREMENTS FOR THE PROCESS
SCHEDULER
Decrease disk I/O

In the original design, messages are assembled immediately by the Assembly Engine and forwarded directly to the Delivery Agent. If the Delivery Agent can not deliver the message, then the assembled message is passed on to the Delivery Scheduler to attempt a second or third delivery option. It is not clear how the Assembly Engine knows that a message was not successfully delivered and therefore needs to be passed to the Delivery Scheduler. Furthermore, assuming the that Assembly Engine decides to pass on ten percent of its messages to the Delivery Scheduler, then the Delivery Scheduler should either hold all those assembled messages in the memory or store them on disk. If you assume that a typical submission contains one million messages, and a typical assembled message is about 15 Kbytes, then there would be 1.5 GBytes of data per submission that would be passed on to the Delivery Scheduler. This is a large amount of data to store in memory—or on disk. This can be avoided by designing the Delivery Scheduler such that it only holds the message templates, the recipient info, and the status of each message. This design would only require a Delivery Scheduler to hold something on the order of several megabytes of data per submission.

Decrease LAN Traffic

Decreases in LAN traffic can be realized by pushing the assembly process further back in the process. This means that the assembled messages pass over the network less frequently. For e-mail messages, the assembly engine may access the SAN and place the messages directly into the Q-mail queues, completely bypassing the normal network traffic associated with SMTP.

Decrease WAN Traffic

Reduced WAN traffic is desirable where the system of the invention is implemented in a highly distributed manner. The amount of WAN traffic may be minimized by never passing assembled messages over the WAN. This also minimizes the amount of database traffic by passing all needed data from the Pre-processor Scheduler directly to the remote Delivery Scheduler so that the Delivery Scheduler does not need to get that data from the database.

Decrease Database Access, Especially Table Scans

Create a Way to Handle Rollovers

A watchdog process may be provided to perform a periodic table scan on the database to determine the state of the messages for a given submission and then initiate the second or third delivery option for a particular recipient. However, table scans are to be avoided as much as is humanly possible, especially on large tables. This may be avoided by assigning the task of tracking the messages for any given submission completely to the Delivery Schedulers. Since there is now one process responsible for tracking the delivery status of all messages, it becomes very clear how to handle rollovers. Any process in the system that identifies the change of a messages state (OOB handler, Web Agents, etc.) can contact the Delivery Scheduler directly to communicate the messages status.

Network Infrastructure

Baseline message volume may require outbound Internet connectivity of T3 (45 Mbits per second) or better. The Network is preferably redundant so that the failure of any one component (switch, router, firewall, circuit, etc.) will not result in a failure of the overall system. The network is preferably monitored for usage of each network segment on a daily, weekly, and monthly basis. E-mail can be generated and sent to the network administrators when the weekly and monthly performance graphs are created. The system preferably has the ability to monitor specific switch and router ports so that specific equipment network bandwidth utilization can be tracked/monitored. A separate VLAN may be provided for the management interfaces for all devices to be monitored.

The system in its preferred embodiment is able to deliver customized messages at high sustained rates, e.g., rates exceeding 1 million 15 KB message per hour. The architecture is distributed and modular in design and volume can be increased by adding resources (network bandwidth, processing systems, database machines, etc.). The system is preferably able to handle peaks of up to 4 times the average (or steady state) level of user traffic.

Use of the system of the invention may be provided as a service to customer companies that desire to send large volumes of custom messages to their users but do not have the capacity to track and administer the actual delivery of the messages themselves. Such customers may include companies that have information which must be delivered via large volumes of time-sensitive messages. Potential users of the system may be, e.g., stock trading companies, catalog companies, electronic bill presentment enterprises, retail outlets, financial institutions, publishing and global Fortune 1000 companies.

While the invention has been particularly shown and described with reference to preferred embodiments thereof, it will be understood by those skilled in the art that various changes in form and details may be made therein without departing from the spirit and scope of the invention.

### Appendix A

### Memo: VERP Versus Message ID Revision: 2.0

### Chris Shenton, Manjusha Gadamsetty, Lee Mann, Gautam Yegnanarayan

### Jun, 15, 2000

1 Introduction

We have been using the phrase “message ID” and “VERP” somewhat interchangably, leading to some confusion on what each is. I would like to avoid “message ID”, leaving it as a database table auto-generated ID used in the “message” table's primary key.

“VERP” is defined by DJB in http://cr.yp.to/proto/verp.txt as a way to identify bounced mail target recipients even from uncooperative remote mail transport agents. The envelop sender is set to a value unique to the intended recipient. A remote MTA is supposed to send bounced mail to the envelop sender (rather than anything in the message headers). When the bounce is received, the original MTA can examine the VERP to determine exactly what recipient failed.

Typically, the recipient's email address is encoded into the VERP since this is usually what is wanted, but it could be anything. We want to use the VERP to identify not just the target email address, but also a “recipient” (which isn't just an email address), its associated submission, customer, etc.

We plan to use this VERP not only for email envelop sender but also within email headers as the Errors-To address, as a component of click-through and invisible image tracking URLs, and other places where we want to track unique messages.

Becuase of this overload of functions, I would prefer to avoid the term “VERP” for this, but we'll need to come up with a term we can all agree to. Perhaps “TrackingID” or some such, but perhaps that's been used already; suggestions welcomed. Until we do come up with a new term, I'll use “VERP” in this paper.

2 Assumptions

2.1 One recipient per message, period

There has been much discussion about the possibility of sending a message which has multiple recipients within the single message connection; we reject this.

While it seems like it might improve efficiency, it precludes the features which are critical to eFoton.

1. Message content cannot be unique to each recipient

2. We can't track which recipient read the message via stealth images or click-throughs.

3. We can't offer recipient-unique web pages from the WAG

4. We can't gather intelligence about the recipient such as mail client, preferred read time, etc.

Since each message will have only one recipient, we can then use a unique identifier on each outbound message to track message delivery, receipt by recipient, and subsequent follow-through by the recipient.

2.2 Expect Brain-damaged MTAs

The VERP must survive transport through brain-damaged MTAs, such as MicroSoft products which truncate values left of the @-sign to 32 characters. Specific suggestions for syntax are discussed below.

3 Variable Encoding Considered Harmful

We initially suggested encoding important variables such as the database MessageID and SubmissionID into the VERP. This section describes why we believe this is not a good idea, but boils down to scalability.

3.1 Variable Transparency is Bad

While it's easy to use something like the MessageID as the VERP, exposing this internal key datum to the world puts the system at risk. A remote user could send mail to the eFoton OOBHandler with the MessageID and it would be interpreted as a bounce; while bad, this only affects the miscreant user. With a transparent VERP they could alter the VERP value and simulate a bounce of someone else's mail—clearly unacceptable. A forged bounce would cause eFoton to roll-over and generate a new message for the “failed” recipient.

We have to protect the privacy of any data we use in the VERP. It should not be possible for the casual miscreant to to affect eFoton with forged email. Ideally, it would be impossible for outsiders to generate email with a forged VERP which would match a real eFoton identifier.

3.2 Scalability

After the initial MessageID proposal, we realized we wanted the SubmissionID available through the VERP as well; it would help us in database queries, possibly saving an additional step. While you could query the database on the MessageID to get the SubmissionID, this represents one extra query. Likewise the SubmissionID can be used to find the CustomerID, SubmissionChunkID, DAtype, and all manner of other data. Perhaps they should be included in the VERP as well. Clearly this is not scalable: there is insufficient room in the VERP to encode all the meta-data about a message. (Below we present some numbers to indicate how much data can be encoded).

3.3 VERP Table

The solution is to implement a database table whose primary is the VERP. Other elements in the table would include all the data one would want to quickly identify from a VERP which enters the eFoton system, such as MessageID, SubmissionChunkID, SubmissionID, CustomerID, RecipientID, MessageExpirationDT.

To prevent data duplication, the other fields in the VERP table would be foreign keys which are indices into other tables. While the VERP table represents an “extra” database query before the system can do any work, it should provide sufficient information to assist subsequent queries, possibly saving later queries in the process. (I'm not sure how we would put the ExpirationDT in the table without actual duplication, unless we have an Expiration table as well).

In actuality, the information in the proposed VERP table is already present in the Message table, so we'll just use that one.

4 What's in a VERP?

How is the VERP constructed? I mean: what's in it? We want to prevent revealing private information and we have limitations on the size of the VERP itself as well as what characters we can use in it.

Since the VERP is not related to the MessageID or any other datum, it can be any arbitrary value—so long as it's unique.

4.1 Opacity and Uniqueness

As discussed above, we must conceal internal data (such as MessageID) to prevent outsiders hacking eFoton's behavior. We could generate random numbers, use hash functions, or timestamps but there are issues with each which must be addressed before implementation.

Using random numbers would require querying the VERP table to see if the proposed number was already used. This could be slow as the VERP table grows.

A hash of some database-generated unique value, such as a monotonically-increasing index value, would almost guarantee uniqueness. Cryptographically-strong hashes are designed with this property. We can modify the format of the hash to use the mathematical “base” appropriate to the VERP envelop, as explained below (e.g., instead of MD5's base-16 we could use base-40 if the alphabet has 40 characters). Curtis expressed concern about the speed of hashes such as “MD5”. Even if the hash is sufficiently fast, are we comfortable with the collision risk level?

A time stamp could be used, but even with a sufficiently small resolution (e.g., DJB's “accustamp”) it's possible multiple messages would be generated in the same single interval. We would need to append some sequence number to prevent this. Keeping track of the sequence may be tedious.

4.2 Length

The VERP is the local-part of the envelop sender address, that is, the stuff before the @-sign. While I can't find any maximum length for this in RFC-822, there are practical limits imposed by brain-damaged MTAs. It has been reported that at least one MicroSoft mail system truncates local-parts which are longer than 32 characters. Therefore, we will restrict the VERP length to be 32 characters.

4.3 Characters

For LatestEdition, Manjusha wrote:

I went through rfc822 document and came out with all valid characters that can be present in the local-part of email addresses where local-part@blah.blah is an email address.

The local-part can contain:

0-9, a-z, A-Z, !, #, $, %, ˆ , &, ′, *, +, −, /, =, ?, _, ‘(Back tick), ˜, {, |, }

Also a “.” (I mean, a period) can be present, but it should not be at the beginning of local-part. I mean, manju.gadams@uucom.com is valid. But .manju@uucom.com is not valid. So, we should, from now on, be able to support and take care of all these characters.

RFC-822 defines the address syntax explicitly; below are the definitions relevant to the local-part:

addr-spec=local-part “@” domain; global address

local-part=word *(“.” word); uninterpreted case-preserved

word=atom/quoted-string

atom=1*<any CHAR except specials, SPACE and CTLs>

quoted-string=<“> *(qtext/quoted-pair) <”>; Regular qtext or quoted chars.

specials=“(“/”)”/“<”/“>”/“@”; Must be in quoted-/“,”/“;”/“:”/“\”/<“>; string, to use /“.”/“[”/“]”; within a word.

qtext=<any CHAR excepting <“>,;=>may be folded “\” & CR, and including linear-white-space>

This reserved local-part must be matched without sensitivity to alphabetic case, so that “POSTMASTER”, “postmaster”, and even “poStmASteR” is to be accepted.

Do all MTAs preserve characters according the the RFC? If not, it would be safest to err on the side of conservatism. Unless we are certain that letter case is preserved, we should restrict ourselves to lower-case. Old mailers treated! and % as mail-path separators, and the pipe operator—is frequently rejected for security reasons. Are there other characters which should be eliminated? Double-quotes must appear in matched pairs, so we'll omit them. I'm suspiscious that mailers will mangle some of those characters like the single quotes (forward and backward), curley braces, and shell meta-characters. Let's play it safe and just use characters which are known to be commonly supported, and include the “.” (dot) and “-” (dash) with the restriction that they may not be used as the first character, per the RFC. So our VERP alphabet is comprised of:

0-9 a-z _+.−

This does leave us with enough room for the information we want to encode, as the math below explains.

4.4 How Many?

The number of possible VERPs is therefore 40³² or about 1.84×10⁵¹ different values. If we assume 10⁶ messages/hour, or about 9×10⁹ messages/year, this means we'll run out of unique VERPs after 2.05×10⁴¹ years. This seems like plenty. :-)

Perhaps the VERP does have “enough room” to encode a variety of different values such as various IDs. For example, if we have 10 variables we want to encode, and each can have a value up to 9e9 (say) then this would require about 3.5×10⁹⁹ unique VERPs. We'd run out very quickly.

While the bit-twiddlers might argue that we won't need a billion values for CustomerID, or even SubmissionID, and maybe we won't want to encode as many as 10 different variables, we'd still only be able to reduce it by orders of magnitude. It still won't scale if we decide down the road that it would be really helpful to have some other kind of ID encoded. Using a VERP table will allow us to add anything we find convenient.

5 Compromise: Encode VERP ID and Critical Data

On May 15, 2000 Jerry, Manjusha and Chris discussed trade-offs of trying to cram a bunch of vital variables into the VERP, putting only the VERP table VerpID primary key, or some combination. The size of the data structure we have to work with is large for a single datum, but rather restrictive if we want to encode multiple possibly-large values.

On May 5, 2000 Chris corrected the VERP size from 30 to 32, which gives us a slightly larger size, but decreased the alphabet from 52 characters to the most conservative 40, which greatly reduces the space.

5.1 Triage Most Critical Information

We realized that although MessageID, RecipientId and such were important, the first thing ever done with a VERP is to check the Expiration data and time. If the expiration time has passed, a simple response is required and future database hits can be eliminated. Therefore encoding the Expiration into the VERP can save us over 50% of our database hits associated with processing OOB bounces, invisible read-tracking images, and click-through URLs.

Obviously, we want to encode a VERP ID which will be used as a key into the Message table which holds foreign keys to the other important tables of interest. This ID must be unique for all time so it is expected to have potentially large values, requiring relatively large storage.

We also want some bits set aside to store a VERP-encoding version, so if we ever decide to change the contents the VERP processors can distinguish formats. Vital, but not very big.

We'll want some kind of checksum on the data to detect tampering and forgery by remote users. A simple checksum would be the one-bit parity on a data byte; it can't detect two-bit errors and can be easily spoofed by an attacker. Strong cryptographic hashes include the MD5 algorithm which has a hash represented by 32 hexadecimal digits; unfortunately our VERP size is too small to encode that. We'll need some compromise here.

Finally, we'll want some world-visible symbol at the front of the VERP to help our VERP processors (especially the OOB Handler looking at randomly-formatted bounce messages) locate VERPs within messages. For example, the SCCS system uses the 4-character string “@(#)” to help it locate SCCS identifiers; the idea is that this string is unlikely to occur in programs and other text. We can use something similar which is unlikely to occur in customer-generated mail, bounces, but fits within the alphabet allowed in a VERP. Note that this must not be encoded like the other data since we need to be able to find it easily in plain-text bounce messages.

5.2 Component Sizing

If we examine the elements we must cram into the VERP in a orderly fashion we can estimate needed sizes and determine that the attributes above will all fit. We'll align each element on VERP character boundaries for ease of access.

5.2.1 Signifier

We'll use a 4-character Signifier selected from our 40-character alphabet, leaving us with 28 characters for the rest of the VERP.

Recall we cannot use “-” or “.” for the first character of our VERP, so we'll make the Signifier the first part and avoid use of these two characters in the first position. We will chose the Signifier to be “e+f0” (ee plus eff zero): starts with an alpha, the plus is unusual in the middle of a username, and the trailing zero will merge with the following VERP ID which may well start with zeros.

5.2.2 VERP ID

If we assume we'll begin with one million messages delivered messages per hour the first year, I think we should consider that we may quickly rise to around ten million message delivery attempts per hour (failed deliveries and re-attempts, increasing demand and increased capacity). If we expect we'll need this many unique IDs each year for ten years, we'll need 10×10⁶×24×365×10=8.76×10¹¹ unique VERP IDs. We can accommodate this with 8-characters in our alphabet because 40⁸=6.55×10¹²; we're left with 20 characters.

5.2.3 Expiration

For now we'll settle on using the UNIX-style date/time which encodes the number of seconds since “the epoch” (Jan. 1, 1970 00:00:00 UTC) in a 4 byte value. This requires 2³²=4.29×10⁹ values. We can fit this into 7-chars in our alphabet because 40⁷=1.64×10¹¹. We have 13 remaining.

(Note that this will run out in Jan. 18, 2038; if we care we will have to use some other time standard, such as TAI, but these will most likely require more precious bits).

5.2.4 Checksum

We'll arbitrarily decide on 4 bytes (64 bits) for the checksum, which consumes 2⁶⁴=1.84×10¹⁹ bits and another 7 characters, leaving 6 characters free.

Note that the checksum should not include the Signifier nor Version in its calculation but must include the VERP ID, Expiration, and Unused (random) values since we want to detect tampering on any of them. Including the unused/random data in the hash will allow us to use the same hash function in the future if we decide to put data there.

The hash should be computed on the three combined fields as represented by the base40 encoded text of the VERP text. This will allow easy parsing of the VERP string, and will detect corruption before any attempt is made to decode the variables represented by the VERP text.

The algorithm is left as an exercise to the implementer. Check Bruce Schneiers's Applied Cryptography for suggestions.

5.2.5 Unused is Random

Any unused space remaining in the VERP should be set to a random value before encoding so that the encoded data will not look like a suspicious string of zeros; the checksums will be calculated including this data to detect tampering.

5.2.6 Version

We'll reserve one of our characters for the VERP version, giving 40 possible versions. Now we're down to 27 characters for the rest of the VERP. Putting the Version character at the end of the VERP text string allows us to avoid ending the userid portion with something which might end in an invalid final email address character such as “.” or “-”. The version, like all other numbers, is encoded with the characters from our base-40 alphabet, starting with “0”.

Note that if we ever change the format of the VERP text or the interpretation of it (e.g., put something useful in the Unused area) then we must increment the Version so that software can decode it properly and other modules can interpret the values correctly.

5.2.7 Does it Fit?

Here is a graphical breakdown of the 32-characters in the VERP and which positions are used for what values.

00000000011111111112222222222333

12345678901234567890123456789012 Position

SSSSVVVVVVVVEEEEEEErrrrrCCCCCCC# Use

UseCodes:

S signifier tag (e+f0)

V VERP ID

E expiration date (4 bytes before encoding)

C checksum of VEr data (4 bytes before encoding)

r random, unused

# version of verp format in use

5.3 Encoding/Decoding

As alluded to in the above, we'd want a pair of verp-encode( ) and verp_decode( ) functions to do all this work for us. We're using character boundaries for each field to simplify the encoding and speed the calculations. Of course all values would have to use our base-40 math to encode the values in the alphabet, using an alphabet which is whose numeric order is exactly as follows:

0123456789abcdefghijklmnopqrstuvwxyz_+.−

5.4 Issues

If the format of the VERP is made public, miscreants can forge VERPs with proper checksums. I've never believed in “security through obscurity” and I know darn well the crypto community has simple solutions for this. Any ideas? Ideally, we could publish the format and still be immune from attack.

Can we find small yet cryptographically-sound hashes? Do we need the entire 4bytes for the digest of such a small “message”?

Some of the VERP space is unused; should we encode an 8byte TAI date/timestamp? A larger checksum? More room for larger VERP IDs?

Can we use the Message.message₁₃ id as the value of the Message.verp_id? If we ever decide to make message_id's non-global (e.g., start at zero with each new submission, separating the namespace by submission number) then we cannot use this.

What is claimed is:

1. A system for delivery of a message to a subscriber over multiple communications channels comprising:
means for accepting the message from a sender;
means for determining a sequence of the communications channels for delivery of the message based on a subscriber profile; and
means for delivery of the message over at least one of the communications channels until acknowledgement of message receipt by the subscriber.

2. The system of claim 1, wherein the message includes at least one of an email, an Instant Message, a video, a fax, a page and a voice message.

3. The system of claim 1, wherein the communications channels are tried sequentially until delivery of the message is acknowledged.

4. The system of claim 1, wherein the message is sent out simultaneously over all communications channels designated by the subscriber in the subscriber profile.

5. The system of claim 1, wherein the communications channels include at least one of Instant Messenger, cellular telephone, telephone land line, email, fax, pager and voice message.

6. The system of claim 1, wherein the acknowledgement includes positive acknowledgement.

7. The system of claim 1, wherein the acknowledgement includes negative acknowledgement.

8. The system of claim 1, wherein the message is converted to a form suitable to the communications channel being used.

9. The system of claim 1, wherein the message is converted from character-based to sound-based for delivery to a voice message.

10. The system of claim 1, wherein the message includes a tag.

11. The system of claim 10, wherein the tag includes message delivery expiration time.

12. The system of claim 1, further including means for monitoring functioning of networks, wherein communication channel selection for the delivery of the message is based on the monitoring.

13. The system of claim 1, further including means for monitoring functioning of email servers, wherein communication channel selection for the delivery of the message is based on the monitoring.

14. The system of claim 1, wherein the means for delivery monitors at least one of the following message delivery status indicators in order to select an optimal communication channel for the delivery of the message: Received for assembly, Assembled, Not Assembled, Reason Not Assembled, Sent via DA/Delivered, Sent via DA/Queued, Sent via DA/Rejected, and Sent to Assembled Message data store.

15. The system of claim 1, wherein the message is delivered based on at least one of subscriber geographical information, subscriber ZIP code, subscriber City, subscriber State, subscriber Country, and subscriber Phone number Area Code, subscriber Time zone data, and subscriber Latitude/Longitude data.

16. The system of claim 1, further including at last one of the following capabilities: Time Lapse, the message must be read within a certain time, and the message be read from a specific device.

17. A method of delivering of a message to a subscriber over multiple communications channels comprising the steps of:
accepting the message from a sender;
determining a sequence of the communications channels for delivery of the message based on a subscriber profile; and
delivering the message over at least one of the communications channels until acknowledgement of message receipt by the subscriber.

18. The method of claim 17, wherein the message includes at least one of an email, an Instant Message, a video, a fax, a page and a voice message.

19. The method of claim 17, wherein the communications channels are tried sequentially until delivery of the message is acknowledged.

20. The method of claim 17, wherein the message is sent out simultaneously over all communications channels designated by the subscriber in the subscriber profile.

21. The method of claim 17 wherein the communications channels include at least one of Instant Messenger, cellular telephone, telephone land line, email, fax, pager and voice message.

22. The method of claim 17, wherein the acknowledgement includes positive acknowledgement.

23. The method of claim 17, wherein the acknowledgement includes negative acknowledgement.

24. The method of claim 17, wherein the message is converted to a form suitable to the communications channel being used.

25. The method of claim 17, wherein the message is converted from character-based to sound-based for delivery to a voice message.

26. The method of claim 17, wherein the message includes a tag.

27. The method of claim 26, wherein the tag includes message delivery expiration time.

28. The method of claim 17, further including the step of monitoring functioning of networks, wherein communication channel selection for the delivery of the message is based on the monitoring.

29. The method of claim 17, further including the step of monitoring functioning of message servers, wherein communication channel selection for the delivery of the message is based on the monitoring.

30. The method of claim 17, wherein the step of delivering the message monitors at least one of the following message delivery status indicators in order to select an optimal communication channel for the delivery of the message: Received for assembly, Assembled, Not Assembled, Reason Not Assembled, Sent via DA/Delivered, Sent via DA/Queued, Sent via DA/Rejected, and Sent to Assembled Message data store.

31. The method of claim 17, wherein the message is delivered based on at least one of subscriber geographical information, subscriber ZIP code, subscriber City, subscriber State, subscriber Country, and subscriber Phone number Area Code, subscriber Time zone data, and subscriber Latitude/Longitude data.

32. The method of claim 17, wherein the delivery step delivers the message subject to at least one of the following restrictions: Time Lapse, the message must be read within a certain time, and the message be read from a specific device.

33. A system for delivering an electronic message comprising:
means for continuously monitoring functioning of communication channels for delivering the message to a subscriber;
means for delivering the message to the subscriber based on a subscriber profile defining priority for the communication channels; and
means for modifying the delivery sequence of the communication channels based on information from the means for continuously monitoring.

34. The system of claim 33, wherein the means for monitoring monitors functioning of networks.

35. The system of claim 33, wherein the means for monitoring monitors functioning of remote servers.

36. The system of claim 33, wherein the means for monitoring monitors availability of remote resources on a network.

37. The system of claim 33, wherein the means for monitoring monitors response times of remote resources on a network.

38. The system of claim 33, wherein the means for monitoring maintains statistics on response times of remote resources on a network.

39. The system of claim 33, wherein the means for monitoring number of failed connections to remote resources on a network.

40. The system of claim 33, wherein the means for monitoring monitors if a remote server is down.

41. A method of delivering an electronic message comprising the steps of:
continuously monitoring functioning of communication channels for delivering the message to a subscriber;
delivering the message to the subscriber based on a subscriber profile defining priority for the communication channels; and
modifying the priority for the communication channels based on information from the means for continuously monitoring.

42. The method of claim 41, wherein the step of monitoring monitors functioning of networks.

43. The method of claim 41, wherein the step of monitoring monitors functioning of remote servers.

44. The method of claim 41, wherein the step of monitoring monitors availability of remote resources on a network.

45. The method of claim 41, wherein the step of monitoring monitors response times of remote resources on a network.

46. The method of claim 41, wherein the step of monitoring maintains statistics on response times of remote resources on a network.

47. The method of claim 41, further including the step of monitoring number of failed connections to remote resources on a network.

48. The method of claim 41, wherein the step of monitoring monitors if a remote server is down.

49. A system for delivery of a message to a subscriber comprising:
means for accepting the message from a sender;
means for adding an expiration time to the message for delivery of the message; and
means for delivery of the message to the subscriber prior to the expiration time;
means for receiving acknowledgement of message receipt by the subscriber.

50. The system of claim 49, wherein the message includes at least one of an email, an Instant Message, a video, a fax, a page and a voice message.

51. The system of claim 49, further including means for delivery of the message over multiple communications channels.

52. The system of claim 49, wherein the communications channels are tried sequentially until delivery of the message is acknowledged.

53. The system of claim 49, wherein the message is sent out simultaneously over all communications channels designated by the subscriber in a subscriber profile.

54. The system of claim 49, wherein the communications channels include at least one of Instant Messenger, cellular telephone, telephone land line, email, fax, pager and voice message.

55. The system of claim 49, wherein the acknowledgement includes at least one of a positive acknowledgement and a negative acknowledgement.

56. The system of claim 49, wherein the message is converted to a form suitable to the communications channel being used.

57. The system of claim 49, wherein the message is converted from character-based to sound-based for delivery to a voice message.

58. The system of claim 49, wherein the message includes a tag.

59. The system of claim 58, wherein the tag includes message delivery expiration time.

60. The system of claim 58, wherein the tag includes globally unique tracking key identifier.

61. The system of claim 58, wherein the tag includes globally unique message identifier.

62. The system of claim 58, wherein the tag includes versioning information.

63. The system of claim 58, wherein the tag includes a security checksum.

64. The system of claim 58, wherein the tag is dependent on a communication channel chosen for delivery of the message.

65. The system of claim 49, further including means for monitoring functioning of networks, wherein communication channel selection for the delivery of the message is based on the monitoring.

66. The system of claim 49, further including means for monitoring functioning of message servers, wherein communication channel selection for the delivery of the message is based on the monitoring.

67. The system of claim 49, wherein the means for delivery monitors at least one of the following message delivery status indicators in order to select an optimal communication channel for the delivery of the message: Received for assembly, Assembled, Not Assembled, Reason Not Assembled, Sent via DA/Delivered, Sent via DA/Queued, Sent via DA/Rejected, and Sent to Assembled Message data store.

68. The system of claim 49, wherein the message is delivered based on at least one of subscriber geographical information, subscriber ZIP code, subscriber City, subscriber State, subscriber Country, and subscriber Phone number Area Code, subscriber Time zone data, and subscriber Latitude/Longitude data.

69. The system of claim 49, further including at last one of the following capabilities: Time Lapse, the message must be read within a certain time, and the message be read from a specific device.

70. A method of delivering a message to a subscriber comprising the steps of:
accepting the message from a sender;
adding an expiration time to the message for delivery of the message; and
delivering the message to the subscriber prior to the expiration time; and
receiving acknowledgement of message receipt by the subscriber.

71. The method of claim 70, wherein the message includes at least one of an email, an Instant Message, a video, a fax, a page and a voice message.

72. The method of claim 70, further including the step of delivery of the message over multiple communications channels.

73. The method of claim 70, wherein, in the delivering step, the communications channels are tried sequentially until delivery of the message is acknowledged.

74. The method of claim 70, wherein the message is sent out simultaneously over all communications channels designated by the subscriber in a subscriber profile.

75. The method of claim 70, wherein the communications channels include at least one of Instant Messenger, cellular telephone, telephone land line, email, fax, pager and voice message.

76. The method of claim 70, wherein the acknowledgement includes at least one of a positive acknowledgement and a negative acknowledgement.

77. The method of claim 70, further including the step of converting the message to a form suitable to the communications channel.

78. The method of claim 70, further including the step of converting the message from character-based to sound-based for delivery to a voice message.

79. The method of claim 70, wherein the message includes a tag.

80. The method of claim 79, wherein the tag includes message delivery expiration time.

81. The system of claim 79, wherein the tag includes globally unique tracking key identifier.

82. The system of claim 79, wherein the tag includes globally unique message identifier.

83. The system of claim 79, wherein the tag includes versioning information.

84. The system of claim 79, wherein the tag includes a security checksum.

85. The method of claim 79, wherein the tag is dependent on a communication channel chosen for delivery of the message.

86. The method of claim 70, further including the step of monitoring functioning of networks, wherein communication channel selection for the delivery of the message is based on the monitoring.

87. The method of claim 70, further including the step of monitoring functioning of message servers, wherein communication channel selection for the delivery of the message is based on the monitoring.

88. The method of claim 70, wherein the delivery step monitors at least one of the following message delivery status indicators in order to select an optimal communication channel for the delivery of the message: Received for assembly, Assembled, Not Assembled, Reason Not Assembled, Sent via DA/Delivered, Sent via DA/Queued, Sent via DA/Rejected, and Sent to Assembled Message data store.

89. The method of claim 70, wherein the message is delivered based on at least one of subscriber geographical information, subscriber ZIP code, subscriber City, subscriber State, subscriber Country, and subscriber Phone number Area Code, subscriber Time zone data, and subscriber Latitude/Longitude data.

90. A system for delivery of a message to a subscriber over multiple communications channels comprising:
means for accepting the message from a sender;
means for adding a channel-dependent tracking ID to the message;
means for determining a sequence of the communications channels for delivery of the message to the subscriber; and
means for delivery of the message over at least one of the communications channels.

91. The system of claim 90, wherein the message includes at least one of an email, an Instant Message, a video, a fax, a page and a voice message.

92. The system of claim 90, wherein the communications channels are tried sequentially until delivery of the message is acknowledged.

93. The system of claim 90, wherein the message is sent out simultaneously over all communications channels designated by the subscriber in a subscriber profile.

94. The system of claim 90, wherein the communications channels include at least one of Instant Messenger, cellular telephone, telephone land line, email, fax, pager and voice message.

95. The system of claim 90, further including means for acknowledgement of message receipt by the subscriber.

96. The system of claim 90, wherein the tracking ID includes expiration time.

97. The system of claim 90, wherein the tracking ID includes globally unique tracking key identifier.

98. The system of claim 90, wherein the tracking ID includes globally unique message identifier.

99. The system of claim 90, wherein the tracking ID includes versioning information.

100. The system of claim 90, wherein the tracking ID includes a security checksum.

101. The system of claim 90, further including means for monitoring functioning of networks, wherein communication channel selection for the delivery of the message is based on the monitoring.

102. The system of claim 90, further including means for monitoring functioning of message servers, wherein communication channel selection for the delivery of the message is based on the monitoring.

103. The system of claim 90, wherein the tracking ID is encoded.

104. A method of delivering a message to a subscriber over multiple communications channels comprising the steps of:
accepting the message from a sender;
adding a channel-dependent tracking ID to the message;
determining a sequence of the communications channels for delivery of the message to the subscriber; and
delivering the message to the subscriber over at least one of the communications channels.

105. The method of claim 104, wherein the message includes at least one of an email, an Instant Message, a video, a fax, a page and a voice message.

106. The method of claim 104, wherein the delivery step tries the communications channels sequentially until delivery of the message is acknowledged.

107. The method of claim 104, wherein, in the delivery step, the message is sent out simultaneously over all communications channels designated by the subscriber in a subscriber profile.

108. The method of claim 104, wherein the communications channels include at least one of Instant Messenger, cellular telephone, telephone land line, email, fax, pager and voice message.

109. The method of claim 104, further including the step of acknowledging message receipt by the subscriber.

110. The method of claim 104, wherein the tracking ID includes expiration time.

111. The method of claim 104, further including the step monitoring functioning of networks, wherein communication channel selection in the delivery step is based on the monitoring.

112. The method of claim 104, further including the step of monitoring functioning of message servers, wherein communication channel selection in the delivery step is based on the monitoring.

113. The method of claim 104, wherein the tracking ID is encoded.

114. The system of claim 104, wherein the tracking ID includes globally unique tracking key identifier.

115. The system of claim 104, wherein the tracking ID includes globally unique message identifier.

116. The system of claim 104, wherein the tracking ID includes versioning information.

117. The system of claim 104, wherein the tracking ID includes a security checksum.

118. A system for managing message delivery over a network comprising:
means for gathering notification events from remote resources using tags embedded in messages;
means for correlating data about the notification events; and
means for continuously sending the messages through a plurality of communication channels prioritized based on the correlating step, until acknowledgement of receipt of the messages by the subscriber.

119. A method of managing message delivery over a network comprising the steps of:
gathering notification events from remote resources using tags embedded in messages;
correlating data about the notification events; and
continuously sending the messages through a plurality of communication channels prioritized based on the correlating step, until knowledgement of receipt of the messages by the subscriber.

120. A system for managing message delivery over a network comprising:
means for determining locations of a sender and a subscriber;
means for prioritizing a plurality of communication channels for optimal delivery of a message based on the locations of the sender and the subscriber; and
means for delivering the messages through the plurality of communication channels, until acknowledgement of receipt of the message by the subscriber.

121. A method of managing message delivery over a network comprising the steps of:
determining locations of a sender and a subscriber;
prioritizing a plurality of communication channels for optimal delivery of a message based on the locations of the sender and the subscriber; and
delivering the messages through the plurality of communication channels, until acknowledgement of receipt of the message by the subscriber.

122. A computer program product for managing message delivery over a network comprising:
means for determining subscriber message retrieval pattern;
means for delivery of a message to a subscriber on a remote resource based on the subscriber message retrieval pattern; and
means for receiving acknowledgement of receipt of the message by the subscriber.

123. A method of managing message delivery over a network comprising the steps of:
determining subscriber message retrieval pattern;
delivering a message to a subscriber on a remote resource based on the subscriber message retrieval pattern; and
receiving acknowledgement of receipt of the message by the subscriber.

124. A computer program product for delivery of a message to a subscriber over multiple communications channels comprising:
a computer usable medium having computer readable program code means embodied in the computer usable medium for causing an application program to execute on a computer system, the computer readable program code means comprising:
computer readable program code means for accepting the message from a sender;
computer readable program code means for determining a sequence of the communications channels for delivery of the message based on a subscriber profile; and
computer readable program code means for delivery of the message over at least one of the communications channels until acknowledgement of message receipt by the subscriber.

125. A computer program product for delivering an electronic message comprising:
a computer usable medium having computer readable program code means embodied in the computer usable medium for causing an application program to execute on a computer system, the computer readable program code means comprising:
computer readable program code means for continuously monitoring functioning of communication channels for delivering the message to a subscriber;
computer readable program code means for delivering the message to the subscriber based on a subscriber profile defining priority for the communication channels; and
computer readable program code means for modifying the priority for the communication channels based on information from the means for continuously monitoring.

126. A computer program product for delivery of a message to a subscriber comprising:
a computer usable medium having computer readable program code means embodied in the computer usable medium for causing an application program to execute on a computer system, the computer readable program code means comprising:
computer readable program code means for accepting the message from a sender;
computer readable program code means for adding an expiration time to the message for delivery of the message; and
computer readable program code means for delivery of the message to the subscriber prior to the expiration time;
computer readable program code means for receiving acknowledgement of message receipt by the subscriber.

127. A computer program product for delivery of a message to a subscriber over multiple communications channels comprising:
a computer usable medium having computer readable program code means embodied in the computer usable medium for causing an application program to execute on a computer system, the computer readable program code means comprising:
computer readable program code means for accepting the message from a sender;
computer readable program code means for adding a channel-dependent tracking ID to the message;
computer readable program code means for determining a sequence of the communications channels for delivery of the message to the subscriber; and
computer readable program code means for delivery of the message over at least one of the communications channels.

128. A computer program product for managing message delivery over a network comprising:
a computer usable medium having computer readable program code means embodied in the computer usable medium for causing an application program to execute on a computer system, the computer readable program code means comprising:
computer readable program code means for gathering notification events from remote resources using tags embedded in messages;
computer readable program code means for correlating data about the notification events; and
computer readable program code means for continuously sending the messages through a plurality of communication channels prioritized based on the correlating step, until acknowledgement of receipt of the messages by the subscriber.

129. A computer program product for managing message delivery over a network comprising:
a computer usable medium having computer readable program code means embodied in the computer usable medium for causing an application program to execute on a computer system, the computer readable program code means comprising:
computer readable program code means for determining locations of a sender and a subscriber;
computer readable program code means for prioritizing a plurality of communication channels for optimal delivery of a message based on the locations of the sender and the subscriber; and
computer readable program code means for delivering the messages through the plurality of communication channels, until acknowledgement of receipt of the message by the subscriber.

130. A computer program product for managing message delivery over a network comprising:
a computer usable medium having computer readable program code means embodied in the computer usable medium for causing an application program to execute on a computer system, the computer readable program code means comprising:
computer readable program code means for determining subscriber message retrieval pattern;
computer readable program code means for delivery of a message to a subscriber on a remote resource based on the subscriber message retrieval pattern; and
computer readable program code means for receiving acknowledgement of receipt of the message by the subscriber.
